(19) United States
(12) Patent Application Publication
(10) Pub. No.: US 2024/0324033 A1
(43) Pub. Date: Sep. 26, 2024

(54) SENSING METHOD AND DEVICE

(71) Applicant: GUANGDONG OPPO MOBILE TELECOMMUNICATIONS CORP., LTD., Dongguan (CN)

(72) Inventors: Ning GAO, Dongguan (CN); Lei HUANG, Singapore (SG)

(21) Appl. No.: 18/678,314

(22) Filed: May 30, 2024

Related U.S. Application Data
(63) Continuation of application No. PCT/CN2021/137573, filed on Dec. 13, 2021.

(51) Int. Cl. H04W 76/10; G01S 13/00; H04W 24/10

(52) U.S. Cl. CPC H04W 76/10; G01S 13/003; H04W 24/10

(57) ABSTRACT

A sensing method includes: sending, by an access point device, a first trigger frame to at least one sensing response device, where the first trigger frame includes sensing reporting setup information, and the sensing reporting setup information is used to determine a target sensing response device for sensing measurement reporting in the at least one sensing response device.

### CROSS-REFERENCE TO RELATED APPLICATION

This application is a continuation application of International Application No. PCT/CN2021/137573, filed on Dec. 13, 2021, which is incorporated herein by reference in its entirety.

### TECHNICAL FIELD

Embodiments of the present disclosure relates to the field of communication, and in particular, to a sensing method and device.

### BACKGROUND

Sensing is a functional enhancement of the 802.11 protocol proposed by the 802.11bf standard, which performs measurement and sensing for the surrounding environment through a wireless signal, thereby enabling many functions, such as detection about whether there are people invading, moving and falling indoors, gesture recognition and three-dimensional image establishment in space. The essence of the sensing is to sense a change of the environment through continuous channel estimation. However, frequently reporting a result of the channel estimation may lead to a large communication overhead and interference to other devices. Therefore, how to implement an efficient sensing measurement reporting is a problem that needs to be solved urgently.

### SUMMARY

A sensing method and a device are provided in the present disclosure.

In a first aspect, a sensing method is provided, where the method includes: sending, by the access point device, a first trigger frame to at least one sensing response device, where the first trigger frame includes sensing reporting setup information, the sensing reporting setup information is used to determine a target sensing response device for sensing measurement reporting in the at least one sensing response device.

In a second aspect, a sensing method is provided, where the method includes: receiving, by an access point device, a first feedback frame sent by at least one sensing response device, where the first feedback frame includes sensing reporting information.

In a third aspect, a sensing method is provided, where the method includes: receiving, by a sensing response device, a first trigger frame sent by an access point device, where the first trigger frame includes sensing reporting setup information, and the sensing reporting setup information is used to determine the sensing response device to perform sensing measurement reporting.

In a fourth aspect, a sensing method is provided, where the method includes: sending, by a sensing response device, a first feedback frame to an access point device, where the first feedback frame includes sensing reporting information.

In a fifth aspect, an access point device is provided, where the access point device is configured to perform the method according to any one of the first aspect to the second aspect or implementations thereof. In some embodiments, the access point device includes a functional module configured to perform the method according to any one of the first aspect to the second aspect or implementations thereof.

In a sixth aspect, a sensing response device is provided, where the sensing response device is configured to perform the method according to any one of the third aspect to the fourth aspect or implementations thereof. In some embodiments, the sensing response device includes a functional module configured to perform the method according to any one of the third aspect to the fourth aspect or implementations thereof.

In a seventh aspect, an access point device is provided, including a processor and a memory. The memory is used to store a computer program, and the processor is used to call and run the computer program stored in the memory to perform the method according to any one of the first aspect to the second aspect or implementations thereof.

In an eighth aspect, a sensing response device is provided, including a processor and a memory. The memory is used to store a computer program, and the processor is used to call and run the computer program stored in the memory to perform the method according to any one of the third aspect to the fourth aspect or implementations thereof.

In a ninth aspect, a chip is provided, where the chip is configured to implement the method according to any one of the first aspect to the fourth aspect or implementations thereof. In some embodiments, the chip includes: a processor, configured to call and run a computer program from a memory to enable a device installed with the chip to perform the method according to any one of the first aspect to the fourth aspect or implementations thereof.

In an tenth aspect, there is provided a non-transitory computer-readable storage medium for storing a computer program, where the computer program causes a computer to execute the method according to any one of the first aspect to the fourth aspect or implementations thereof.

In an eleventh aspect, there is provided a computer program product, including computer program instructions, which cause a computer to execute the method according to any one of the first aspect to the fourth aspect or implementations thereof.

In a twelfth aspect, a computer program is provided, where the computer program, upon being run on a computer, causes the computer to execute the method according to any one of the first aspect to the fourth aspect or implementations thereof.

### BRIEF DESCRIPTION OF THE DRAWINGS

FIG. 1 is a schematic diagram of an architecture of a communication system provided in embodiments of the present disclosure.

FIGS. 2A to 2J are schematic diagrams of a process of Wi-Fi sensing.

FIG. 3 is a schematic diagram of interactions of a sensing measurement setting phase according to the embodiments of the present disclosure.

FIG. 4 is a schematic diagram of interactions of a sensing measurement phase according to the embodiments of the present disclosure.

FIG. 5 is a schematic diagram of interactions of a sensing reporting phase according to the embodiments of the present disclosure.

FIG. 6 is a schematic diagram of interactions of a sensing method provided in the embodiments of the present disclosure.

FIG. 7 is a schematic diagram of a frame format of a first trigger frame provided in the embodiments of the present disclosure.

FIG. 8 is another schematic diagram of a frame format of a first trigger frame provided in the embodiments of the present disclosure.

FIG. 9 is yet another schematic diagram of a frame format of a first trigger frame provided in the embodiments of the present disclosure.

FIG. 10 is a further schematic diagram of a frame format of a first trigger frame provided in the embodiments of the present disclosure.

FIG. 11 is a schematic diagram of a frame format of a first feedback frame provided in the embodiments of the present disclosure.

FIG. 12 is another schematic diagram of a frame format of a first feedback frame provided in the embodiments of the present disclosure.

FIG. 13 is yet another schematic diagram of a frame format of a first feedback frame provided in the embodiments of the present disclosure.

FIG. 14 is a schematic block diagram of an access point device provided in the embodiments of the present disclosure.

FIG. 15 is another schematic block diagram of an access point device provided in the embodiments of the present disclosure.

FIG. 16 is a schematic block diagram of a sensing response device provided in the embodiments of the present disclosure.

FIG. 17 is another schematic block diagram of a sensing response device provided in the embodiments of the present disclosure.

FIG. 18 is a schematic block diagram of a communication device provided in the embodiments of the present disclosure.

FIG. 19 is a schematic block diagram of a chip provided in the embodiments of the present disclosure.

FIG. 20 is a schematic block diagram of a communication system provided in the embodiments of the present disclosure.

### DETAILED DESCRIPTION

Technical solutions in the embodiments of the present disclosure will be described below with reference to the accompanying drawings in the embodiments of the present disclosure. Obviously, the described embodiments are merely some but not all of the embodiments of the present disclosure. All other embodiments obtained based on the embodiments of the present disclosure by a person of ordinary skill in the art shall be included in the protection scope of the present disclosure.

In the embodiments, a sensing method is provided, which includes:
sending, by an access point device, a first trigger frame to at least one sensing response device, where the first trigger frame includes sensing reporting setup information, the sensing reporting setup information is used to determine a target sensing response device for sensing measurement reporting in the at least one sensing response device.

In some embodiments, the sensing reporting setup information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device; or threshold setting information, used to indicate a threshold that the sensing response device needs to satisfy for feeding back the change of the sensing measurement result.

In some embodiments, the first trigger frame includes an extremely high throughput (EHT) variant common information field and an EHT variant user information field, and the sensing reporting setup information is carried in the EHT variant common information field and/or the EHT variant user information field.

In some embodiments, the EHT variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the EHT variant common information field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the EHT variant user information field includes:
a threshold setting field, used to indicate a threshold that a station device corresponding to the EHT variant user information field needs to satisfy for feeding back a change of a sensing measurement result.

In some embodiments, the EHT variant common information field includes a field of a sensing trigger frame subtype, and the sensing trigger frame subtype is used to indicate a subtype of a sensing trigger frame being a sensing feedback poll trigger frame.

In some embodiments, the first trigger frame includes a high efficiency (HE) variant common information field and a HE variant user information field, and the sensing reporting setup information is carried in the HE variant common information field and/or the HE variant user information field.

In some embodiments, the HE variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the HE variant common information field includes at least one of the following fields:
a measurement instance identity field, used to indicate an identity of a measurement instance;
a measurement setup identity field, used to indicate an identity of measurement setup; or a feedback type information field, used to indicate a data type of a change of a sensing
measurement result fed back by the sensing response device.

In some embodiments, the HE variant user information field includes:
a threshold setting field, used to indicate a threshold that a station device corresponding to the HE variant user information field needs to satisfy for feeding back a change of a sensing measurement result.

In some embodiments, the HE variant common information field includes a field of a sensing trigger frame subtype, and the sensing trigger frame subtype is used to indicate a subtype of a sensing trigger frame being a sensing feedback poll trigger frame.

In some embodiments, the method further includes:
receiving, by the access point device, a first feedback frame sent by the at least one sensing response device, where the first feedback frame includes sensing reporting information.

In some embodiments, the sensing reporting information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device;
threshold setting information, used to indicate a threshold of the sensing response device being used to feed back the change of the sensing measurement result; or
information of the change of the sensing measurement result, used to indicate the change of the sensing measurement result fed back by the sensing response device.

In some embodiments, the first feedback frame is an action frame.

In some embodiments, the first feedback frame includes an aggregation control (A-Control) field, and the sensing reporting information is carried in the A-Control field.

In the embodiments, a sensing method is provided, which includes:
receiving, by an access point device, a first feedback frame sent by at least one sensing response device, where the first feedback frame includes sensing reporting information.

In some embodiments, the sensing reporting information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device;
threshold setting information, used to indicate a threshold of the sensing response device being used to feed back the change of the sensing measurement result; or
information of the change of the sensing measurement result, used to indicate the change of the sensing measurement result fed back by the sensing response device.

In some embodiments, the first feedback frame is an action frame.

In some embodiments, the first feedback frame is a public action frame or a sensing action frame.

In some embodiments, the first feedback frame includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a public action frame, the first feedback frame includes an action type field and a public action field, the action type field is used to indicate that the action frame is a public action frame, and a value of the public action domain field being a reserved value is used to indicate that the public action frame is a sensing feedback frame.

In some embodiments, the first feedback frame is a sensing action frame, the first feedback frame includes an action type field and a sensing action field, and a value of the action type field being a reserved value is used to indicate that the action frame is a sensing action frame, and the sensing action field is used to indicate that the sensing action frame is a sensing feedback frame.

In some embodiments, the first feedback frame includes an aggregation control (A-Control) field, and the sensing reporting information is carried in the A-Control field.

In some embodiments, the A-Control field includes a control identity field and a control information field, where the control identity field is used to indicate that the control information field is used to carry the sensing reporting information, and the control information field is used to carry the sensing reporting information.

In some embodiments, the control information field includes at least one of the following:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a data frame or a management frame.

In some embodiments, the method further includes:
sending, by the access point device, a first trigger frame to the at least one sensing response device, where the first trigger frame includes sensing reporting setup information, and the sensing reporting setup information is used to determine a target sensing response device for sensing measurement reporting in the at least one sensing response device.

In some embodiments, the sensing reporting setup information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device; or
threshold setting information, used to indicate a threshold that the sensing response device needs to satisfy for feeding back the change of the sensing measurement result.

In some embodiments, the first trigger frame includes an extremely high throughput (EHT) variant common information field and an EHT variant user information field, and the sensing reporting setup information is carried in the EHT variant common information field and/or the EHT variant user information field.

In some embodiments, the first trigger frame includes a high efficiency (HE) variant common information field and a HE variant user information field, and the sensing reporting setup information is carried in the HE variant common information field and/or the HE variant user information field.

In the embodiments, a sensing method is provided, which includes:
receiving, by a sensing response device, a first trigger frame sent by an access point device, where the first trigger frame includes sensing reporting setup information, and the sensing reporting setup information is used to determine the sensing response device to perform sensing measurement reporting.

In some embodiments, the sensing reporting setup information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device; or
threshold setting information, used to indicate a threshold that the sensing response device needs to satisfy for feeding back the change of the sensing measurement result.

In some embodiments, the first trigger frame includes an extremely high throughput (EHT) variant common information field and an EHT variant user information field, and the sensing reporting setup information is carried in the EHT variant common information field and/or the EHT variant user information field.

In some embodiments, the EHT variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the EHT variant common information field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the EHT variant user information field includes:
a threshold setting field, used to indicate a threshold that a station device corresponding to the EHT variant user information field needs to satisfy for feeding back a change of a sensing measurement result.

In some embodiments, the EHT variant common information field includes a field of a sensing trigger frame subtype, and the sensing trigger frame subtype is used to indicate a subtype of a sensing trigger frame being a sensing feedback poll trigger frame.

In some embodiments, the first trigger frame includes a high efficiency (HE) variant common information field and a HE variant user information field, and the sensing reporting setup information is carried in the HE variant common information field and/or the HE variant user information field.

In some embodiments, the HE variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the HE variant common information field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the HE variant user information field includes:
a threshold setting field, used to indicate a threshold that a station device corresponding to the HE variant user information field needs to satisfy for feeding back a change of a sensing measurement result.

In some embodiments, the HE variant common information field includes a field of a sensing trigger frame subtype, and the sensing trigger frame subtype is used to indicate a subtype of a sensing trigger frame being a sensing feedback poll trigger frame.

In some embodiments, the method further includes:
sending, by the sensing response device, a first feedback frame to the access point device, where the first feedback frame includes sensing reporting information.

In some embodiments, the sensing reporting information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device;
threshold setting information, used to indicate a threshold of the sensing response device being used to feed back the change of the sensing measurement result; or
information of the change of the sensing measurement result, used to indicate the change of the sensing measurement result fed back by the sensing response device.

In some embodiments, the first feedback frame is an action frame.

In some embodiments, the first feedback frame includes an aggregation control (A-Control) field, and the sensing reporting information is carried in the A-Control field.

In the embodiments, a sensing method is provided, which includes:
sending, by a sensing response device, a first feedback frame to an access point device, where the first feedback frame includes sensing reporting information.

In some embodiments, the sensing reporting information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device;
threshold setting information, used to indicate a threshold of the sensing response device being used to feed back the change of the sensing measurement result; or
information of the change of the sensing measurement result, used to indicate the change of the sensing measurement result fed back by the sensing response device.

In some embodiments, the first feedback frame is an action frame.

In some embodiments, the first feedback frame is a public action frame or a sensing action frame.

In some embodiments, the first feedback frame includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a public action frame, the first feedback frame includes an action type field and a public action field, the action type field is used to indicate that the action frame is a public action frame, and a value of the public action domain field being a reserved value is used to indicate that the public action frame is a sensing feedback frame.

In some embodiments, the first feedback frame is a sensing action frame, the first feedback frame includes an action type field and a sensing action field, and a value of the action type field being a reserved value is used to indicate that the action frame is a sensing action frame, and the sensing action field is used to indicate that the sensing action frame is a sensing feedback frame.

In some embodiments, the first feedback frame includes an aggregation control (A-Control) field, and the sensing reporting information is carried in the A-Control field.

In some embodiments, the A-Control field includes a control identity field and a control information field, where the control identity field is used to indicate that the control information field is used to carry the sensing reporting information, and the control information field is used to carry the sensing reporting information.

In some embodiments, the control information field includes at least one of the following:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a data frame or a management frame.

In some embodiments, the method further includes:
receiving, by the sensing response device, a first trigger frame sent by the access point device, where the first trigger frame includes sensing reporting setup information, and the sensing reporting setup information is used to determine the sensing response device to perform sensing measurement reporting.

In some embodiments, the sensing reporting setup information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device; or
threshold setting information, used to indicate a threshold that the sensing response device needs to satisfy for feeding back the change of the sensing measurement result.

In some embodiments, the first trigger frame includes an EHT variant common information field and an EHT variant user information field, and the sensing reporting setup information is carried in the EHT variant common information field and/or the EHT variant user information field.

In some embodiments, the first trigger frame includes a HE variant common information field and a HE variant user information field, and the sensing reporting setup information is carried in the HE variant common information field and/or the HE variant user information field.

The technical solutions in the embodiments of the present disclosure can be applied to various communication systems, such as wireless local area networks (Wireless Local Area Networks, WLAN), wireless fidelity (Wireless Fidelity, WiFi) or other communication systems.

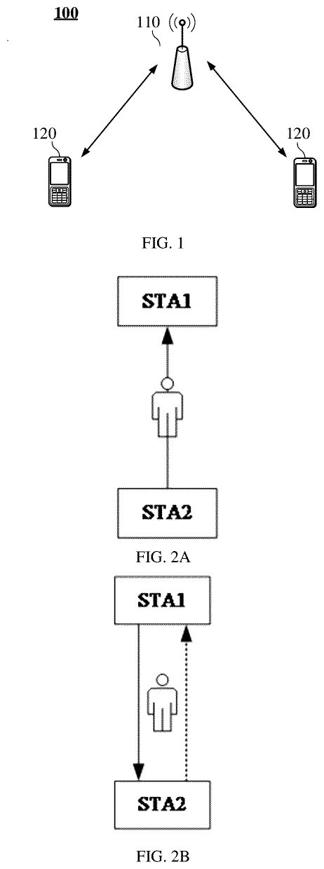

For example, a communication system 100 applied in the embodiments of the present disclosure is shown in FIG. 1. The communication system 100 may include an access point (Access Point, AP) 110, and a station (STATION, STA) 120 that accesses the network through the access point 110.

In some scenarios, the AP is also called an AP STA, that is, in a certain sense, the AP is also a kind of STA.

In some scenarios, STA is also called non-AP STA (non-AP STA).

The communication in the communication system 100 may be a communication between the AP and the non-AP STA, may also be a communication between the non-AP STA and the non-AP STA, or a communication between the STA and a peer STA, where the peer STA may refer to a device that performs peer-to-peer communication with the STA. For example, the peer STA may be an AP or a non-AP STA.

The AP is equivalent to a bridge for connecting a wired network and a wireless network. The main function of the AP is to connect various wireless network clients together, and then connect the wireless network clients to the Ethernet. The AP device may be a terminal device (such as a mobile phone) or a network device (such as a router) with a WiFi chip.

It should be understood that the role of the STA in the communication system is not absolute. For example, in some scenarios, when a mobile phone is connected to the router, the mobile phone is a non-AP STA. When the mobile phone is used as a hotspot for other mobile phones, the mobile phone acts as an AP.

The AP and the non-AP STA may be: devices used in the Internet of Vehicles; Internet of Things (Internet Of Things, IoT) nodes, sensors and the like in the IoT; smart cameras, smart remote controls, smart water and electricity meters and the like in the smart home; and sensors in the smart city.

In some embodiments, the non-AP STA may support the 802.11be standard. The non-AP STA may also support multiple current and future 802.11 family wireless local area networks (wireless local area networks, WLAN) standards such as 802.11ax, 802.11ac, 802.11n, 802.11g, 802.11b, and 802.11a.

In some embodiments, the AP may be a device supporting the 802.11be standard. The AP may also be a device that supports various current and future 802.11 family WLAN standards, such as 802.11ax, 802.11ac, 802.11n, 802.11g, 802.11b, and 802.11a.

In the embodiments of the present disclosure, the STA may be: a mobile phone (Mobile Phone), a pad (Pad), a computer, a virtual reality (Virtual Reality, VR) device, and an augmented reality (Augmented Reality, AR) device that supports WLAN or WiFi technology a wireless device in the industrial control, a set-top box, a wireless device in the self-driving (self driving), a vehicle-mounted communication device, a wireless device in the remote medical (remote medical), a wireless device in the smart grid (smart grid), a wireless device in the transportation safety (transportation safety), a wireless device in the smart city (smart city) or a wireless device in the smart home (smart home), a wireless communication chip/ASIC/SOC/, etc.

Frequency bands that the WLAN technology can support may include but not be limited to: low frequency bands (such as 2.4 GHz, 5 GHz, 6 GHz) and high frequency bands (such as 60 GHz).

FIG. 1 exemplarily shows one AP STA and two non-AP STAs. Optionally, the communication system 100 may include multiple AP STAs and other numbers of non-AP STAs, which is not limited in the embodiments of the present disclosure.

It should be understood that devices with communication functions in the network/system in the embodiments of the present disclosure can be called communication devices. Taking the communication system 100 shown in FIG. 1 as an example, the communication device may include an access point 110 and stations 120 with communication functions. The access point 110 and the stations 120 may be devices described above, which may not be repeated herein. The communication device may also include other devices in the communication system 100, such as a network controller, a gateway and other network entities, which are not limited in the embodiments of the present disclosure.

It should be understood that the terms “system” and “network” are often used interchangeably herein. The term “and/or” herein is only an association relationship to describe associated objects, which indicates that there may be three kinds of relationships, for example, A and/or B may indicate three cases where: A exists alone, both A and B exist, and B exists alone. In addition, a character “/” herein generally indicates that related objects before and after “/” are in an “or” relationship.

It should be understood that “indication” and variations thereof involved in embodiments of the present disclosure may be a direct indication, may be an indirect indication, or may represent an association relationship. For example, A indicating B may mean that A indicates B directly, for example, B can be acquired through A; or A indicating B may mean that A indicates B indirectly, for example, A indicates C, and B can be acquired through C; or A indicating B may mean that there is an association between A and B.

In the description of the embodiments of the present disclosure, the term “correspond” and variations thereof may mean that there is a directly corresponding relationship or an indirectly corresponding relationship between two parties, or mean that there is an association between two parties, or mean a relationship such as indicating and being indicated, or configuring and being configured.

In the embodiments of the present disclosure, the term “predefined” and variations thereof may be achieved by pre-storing corresponding codes, tables or other approaches that can be used to indicate relevant information in the devices (for example, including the access point and station), and the implementation is not limited in the present disclosure. For example “predefined” may refer to what is defined in the protocol.

In order to facilitate the understanding of the technical solutions of the embodiments of the present disclosure, relevant terms of the present disclosure are described below.

Association identifier (Association Identifier, AID) is used to identify a terminal that establishes an association with an access point.

Medium access control (Medium Access Control, MAC), that is, an abbreviation of medium access control address.

Transmission opportunity (Transmission Opportunity, TXOP) refers to a period of time during which a terminal with the transmission opportunity can actively initiate one or more transmissions.

Burst signal (Burst) refers to a short period of time in which one or more signals are sent.

Burst signal group (Burst Group) refers to a combination of one or more bursts. Bursts in the same burst group generally have some common characteristics.

Sensing (Sensing) measurement is to sense people or objects in the environment by measuring a change in a signal scattered and/or reflected by the people or the objects. That is, Sensing measurement is to measure and sense the surrounding environment through wireless signals, thereby enabling many functions, such as detection about whether there are people invading, moving and falling indoors, posture recognition and three-dimensional image establishment in space.

Devices participating in the sensing measurement may include the following roles (role):
a sensing initiating device (Sensing Initiator), which is a device that initiates a sensing session (sensing session) and wants to acquire a sensing result;
a sensing response device (Sensing Responder), which is a non-sensing initiator device that participates in the sensing session;
a sensing transmitting device (Sensing Transmitter), which is a device that initiates a sensing measurement signal (sensing illumination signal), and is also referred to as a sensing signal transmitting device;
a sensing receiving device (Sensing Receiver), which is a device that receives a sensing measurement signal (sensing illumination signal), and is also referred to as a sensing signal receiving device;
a sensing processing device (Sensing processor), which is a device that processes a sensing measurement result;
a sensing participating device (Sensing Participant), which includes the sensing initiating device, the sensing transmitting device and the sensing receiving device.

A device may have one or more roles in a sensing measurement. For example, the sensing initiating device may only be a sensing initiating device, but may also be a sensing transmitting device, or a sensing receiving device, or may be the sensing transmitting device and the sensing receiving device at the same time.

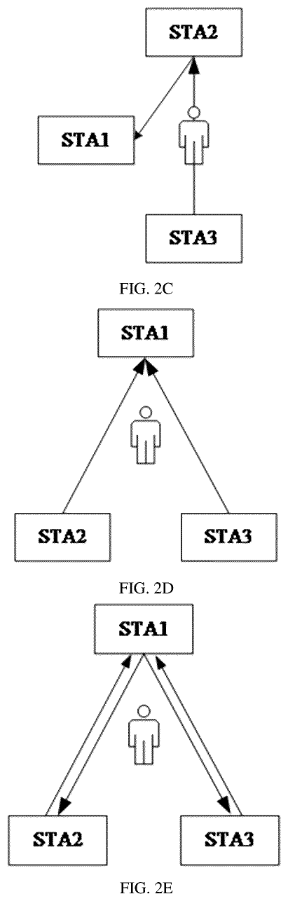

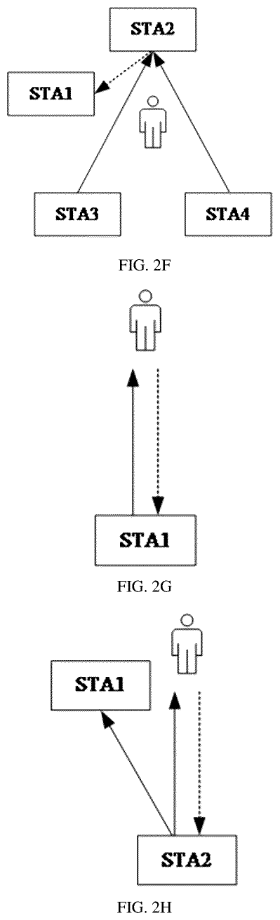

For example, as shown in FIG. 2A, STA1 may be a sensing initiating device (Sensing Initiator), a sensing receiving device (Sensing Receiver), or a sensing processing device (Sensing processor); STA2 may be a sensing transmitting device (Sensing Transmitter).

For another example, as shown in FIG. 2B, STA1 may be a sensing initiating device (Sensing Initiator) or a sensing transmitting device (Sensing Transmitter); STA2 may be a sensing receiving device (Sensing Receiver) or a sensing processing device (Sensing processor).

For another example, as shown in FIG. 2C, STA1 may be a sensing initiating device (Sensing Initiator) or a sensing processing device (Sensing processor); STA2 may be a sensing receiving device (Sensing Receiver); STA3 may be a sensing transmitting device (Sensing Transmitter).

For another example, as shown in FIG. 2D, STA1 may be a sensing initiating device (Sensing Initiator), a sensing receiving device (Sensing Receiver), or a sensing processing device (Sensing processor); STA2 may be a sensing transmitting device (Sensing Transmitter); STA3 may be a sensing transmitting device (Sensing Transmitter).

For another example, as shown in FIG. 2E, STA1 may be a sensing initiating device (Sensing Initiator), a sensing transmitting device (Sensing Transmitter), or a sensing processing device (Sensing processor); STA2 may be a sensing receiving device (Sensing Receiver); STA3 may be a sensing receiving device (Sensing Receiver).

For another example, as shown in FIG. 2F, STA1 may be a sensing initiating device (Sensing Initiator); STA2 may be a sensing receiving device (Sensing Receiver), or a sensing processing device (Sensing processor); STA3 may be a sensing transmitting device (Sensing Transmitter); STA4 may be a sensing transmitting device (Sensing Transmitter).

For another example, as shown in FIG. 2G, STA1 may be a sensing initiating device (Sensing Initiator), a sensing transmitting device (Sensing Transmitter), a sensing receiving device (Sensing Receiver), or a sensing processing device (Sensing processor).

For another example, as shown in FIG. 2H, STA1 may be a sensing initiating device (Sensing Initiator); STA2 may be a sensing transmitting device (Sensing Transmitter), a sensing receiving device (Sensing Receiver), or a sensing processing device (Sensing processor).

For another example, as shown in FIG. 2I, STA1 may be a sensing initiating device (Sensing Initiator), a sensing transmitting device (Sensing Transmitter), a sensing receiving device (Sensing Receiver), or a sensing processing device (Sensing processor); STA2 may be a sensing transmitting device (Sensing Transmitter), or a sensing receiving device (Sensing Receiver).

For another example, as shown in FIG. 2J, STA1 may be a sensing initiating device (Sensing Initiator), or a sensing processing device (Sensing processor); STA2 may be a sensing transmitting device (Sensing Transmitter), or a sensing receiving device (Sensing Receiver); STA3 may be a sensing transmitting device (Sensing Transmitter), or a sensing receiving device (Sensing Receiver).

In some embodiments of the present disclosure, the sensing initiating device is also referred to as an initiator, or a sensing session initiating device, the sensing response device is also referred to as a response device, or a sensing session response device.

A WLAN sensing session includes one or more of the following phases: a session establishment, a sensing measurement, sensing reporting, and session termination.

Session establishment phase: a sensing session is established, a sensing session participant and role thereof (including a sensing signal transmitting device and a sensing signal receiving device) are determined, an operating parameter related to the sensing session is determined, and optionally, this parameter is interacted between terminals.

Sensing measurement phase: a sensing measurement is implemented, and the sensing signal transmitting device sends a sensing signal to the sensing signal receiving device.

Sensing reporting phase: a measurement result is reported, and depending on an application scenario, the sensing signal receiving device may need to report the measurement result to the sensing session initiating device.

Session termination phase: the terminal stops measurement, and terminates the sensing session.

Upon establishing the sensing session, sensing roles and operating parameters may need to be negotiated one by one between terminals, or the terminals declare their own roles and operating parameters (e.g., through a beacon frame or other special frames).

The data volume of a sensing measurement result is usually relatively large, for example, data of channel state information (Channel State Information, CSI) measured in one measurement may reach 4K to 40K bits. In order to reduce the network load caused by reporting the sensing measurement results, a measurement threshold may be set. When a value of a change between a current sensing measurement result and a previous sensing measurement result is less than the measurement threshold, the sensing signal receiving device reports the sensing measurement result. Otherwise, the sensing measurement result may not be reported.

The sensing session initiating device may set multiple sets of measurement parameters. A set of measurement parameters (identified by a measurement setup identity (Measurement Setup ID), which may be equivalent to a burst group (Burst Group)) may be applied to multiple times of measurements (identified by the measurement instance ID (Measurement Instance ID), which may be equivalent to a burst (Burst)).

In some embodiments, in order to reduce the overhead of sensing measurement reporting and interference to other devices, a process of trigger frame based (Trigger Based, TB) measurement may be performed, including three phases: a sensing measurement setup phase, a sensing measurement phase, and a sensing measurement reporting phase. In the sensing measurement setup phase, operating parameters for implementing sensing measurement are interacted or negotiated, that is, measurement setup. In the sensing measurement phase, a sensing measurement is implemented based on the measurement setup, and in the sensing measurement reporting phase, measurement results are reported.

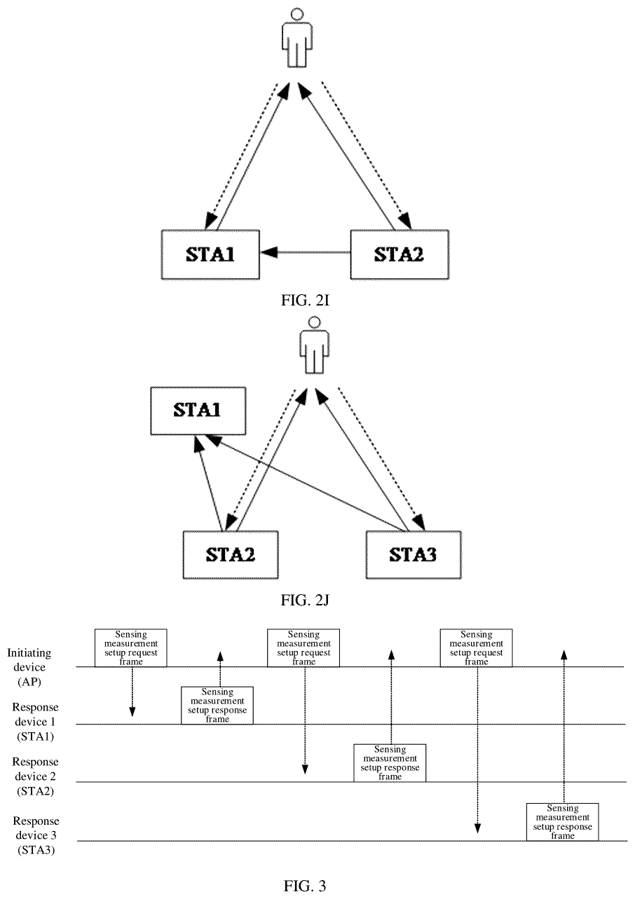

FIG. 3 is a schematic diagram of interactions of the sensing measurement setup phase. As shown in FIG. 3, in the sensing measurement setup phase, the sensing initiating device (such as an AP device) and at least one sensing response device determine operating parameters for implementing a measurement (i.e., measurement setup) through a sensing measurement setup request frame and a sensing measurement setup response frame.

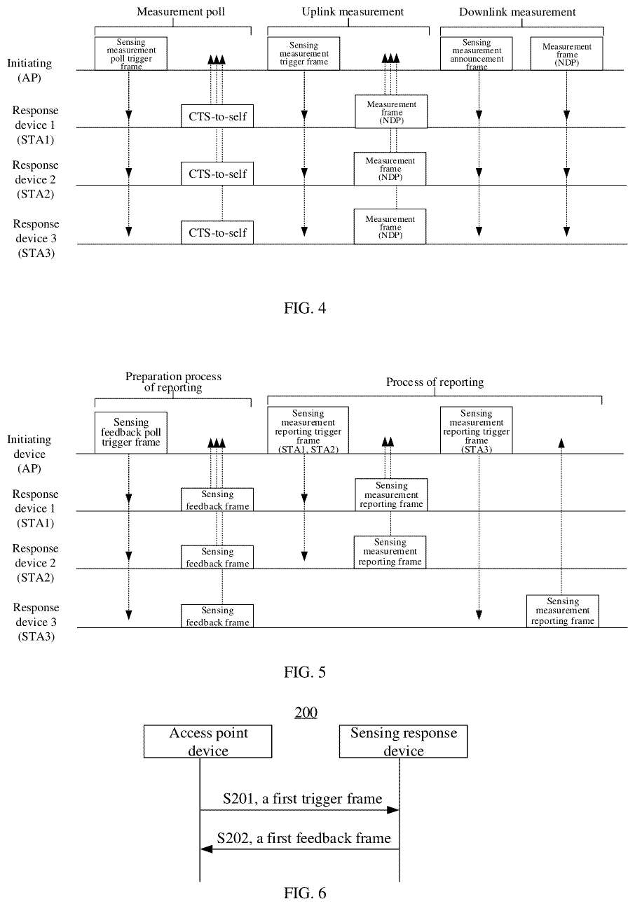

FIG. 4 is a schematic diagram of interactions of the sensing measurement phase. As shown in FIG. 4, in the sensing measurement phase, the sensing initiating device (such as an AP device) determines the sensing response device that performs the measurement through a sensing measurement poll trigger frame, and further triggers the sensing response device that performs the measurement to send a measurement frame (for example, a null data physical layer protocol data unit (Null data PPDU, NDP)) for uplink measurement through a sensing measurement trigger frame, and notifies the sensing response device to receive the measurement frame through the NDP announcement (NDP Announcement, NDPA) for downlink measurement.

FIG. 5 is a schematic diagram of interactions of the sensing reporting phase. As shown in FIG. 5, in the sensing reporting phase, the sensing initiating device (such as an AP device) determines the sensing response device that performs a measurement reporting through a sensing feedback poll trigger frame. In response to the sensing feedback poll trigger frame, the sensing response device may send a sensing feedback frame to an access point device. Further, the access point device performs sensing measurement reporting through sensing measurement reporting trigger frame and sensing measurement reporting frame sent by the sensing response device. The sensing feedback frame may be carried through a TB physical protocol data unit (Physical Protocol Data Unit, PPDU).

In a case that since there are multiple types of physical (Physical, PHY) versions in PPDU, or in other words, different station devices support transmitting PPDUs with different PHY versions (e.g., a PPDU with an extremely high throughput (Extremely High Throughput, EHT) PHY version, or a PPDU with high efficiency (High Efficiency, HE) PHY version), how to report trigger based sensing measurements is an urgent problem that needs to be solved.

In order to facilitate the understanding of the technical solutions of the embodiments of the present disclosure, the technical solutions of the present disclosure are described in detail below through some embodiments. The above-related technologies may be arbitrarily combined with the technical solutions of the embodiments of the present disclosure as optional solutions, which all fall within the protection scope of the embodiments of the present disclosure. The embodiments of the present disclosure include at least part of the following contents.

FIG. 6 is a schematic diagram of a sensing method 200 according to the embodiments of the present disclosure. As shown in FIG. 6, the method 200 includes the following content.

Embodiment 1: in S201, an access point device sends a first trigger frame to at least one sensing response device.

Correspondingly, the sensing response device receives the first trigger frame sent by the access point device.

Embodiment 2: in S202, the access point device receives a first feedback frame sent by the at least one sensing response device.

Correspondingly, the sensing response device sends the first feedback frame to the access point device.

It should be understood that in the present disclosure, Embodiment 1 and Embodiment 2 may be implemented individually or in combination, which may not be limited in the present disclosure.

Optionally, in the embodiments of the present disclosure, the access point device may be a sensing initiating device, or may be a proxy device (proxy) of the sensing initiating device. For example, when the sensing initiating device is a non-AP STA, the non-AP STA may trigger sensing reporting through the proxy device.

Optionally, in the embodiments of the present disclosure, the sensing response device may refer to a station device, and a number of the sensing response devices is not limited in the present disclosure.

It should be noted that in the embodiments of the present disclosure, unless otherwise specified, the access point devices all refer to APs, or AP STAs, and the station devices all refer to non-AP STAs.

Embodiment 1 and Embodiment 2 may be described below respectively with reference to some embodiments.

### Embodiment 1

In some embodiments of the present disclosure, the first trigger frame includes sensing reporting setup information, and the sensing response device that receives the first trigger frame may perform sensing measurement reporting based on the sensing reporting setup information, for example, determine whether to perform sensing measurement reporting, or determine a reported data type, etc. Therefore, the access point device may determine a target sensing response device (such as a number of target sensing response devices and/or a device identity of the target sensing response device, such as an AID, or an unassociated ID (Unassociated ID, UID)) that performs sensing measurement reporting based on a feedback on the first trigger frame from the sensing response device.

In the embodiments of the present disclosure, the first trigger frame may also be referred to as a sensing feedback poll trigger frame, or may also be replaced with other similar names, and a specific name of the first trigger frame may not be limited in the present disclosure.

In some embodiments of the present disclosure, the sensing reporting setup information includes at least one of the following:
a measurement instance identity, used to identify a measurement instance;
a measurement setup identity, used to identify measurement setup for performing the measurement instance indicated by the measurement instance identity;
feedback type information (or referred to as poll feedback type information), used to indicate a data type of a change of a sensing measurement result fed back by the sensing response device; or
threshold setting information, used to indicate a threshold that the sensing response device needs to satisfy for feeding back the change of the sensing measurement result.

In some embodiments, the measurement instance identity may indicate a measurement instance that has been performed.

In some embodiments, the measurement setup identity may indicate a measurement setup used to perform a performed measurement instance.

In some embodiments, the feedback type information may indicate that a data type of the change of the sensing measurement result fed back by the sensing response device is Boolean data, for example, indicating whether the change of the sensing measurement result is greater than a threshold, or the feedback type information may indicate that a data type of the change of the sensing measurement result fed back by the sensing response device is integer data, for example, indicate a specific value of the change of the sensing measurement result.

In some embodiments, the change of the sensing measurement result may refer to a change rate (for example, 15%, 50%, etc.) of a sensing measurement result of a current measurement instance with respect to a sensing measurement result of a previous measurement instance, or may also refer to a change amount of a sensing measurement result of a current measurement instance with respect to a sensing measurement result of a previous measurement instance, where the current measurement instance may refer to a measurement instance indicated by a measurement instance identity in the sensing reporting setup information. A representation way of the change of the sensing measurement result is not limited in the present disclosure. Below, the change of the sensing measurement result being represented by a change rate of the measurement result is taken as an example, however, the present disclosure is not limited thereto.

Therefore, in the embodiments of the present disclosure, the sensing response device may, according to the sensing reporting setup information in the first trigger frame upon performing sensing measurement reporting, determine a threshold that needs to be satisfied by the change of the sensing measurement result, and report a data type of the change of the sensing measurement result.

For example, the sensing response device may perform sensing measurement reporting upon the change of sensing measurement result satisfies the threshold, where the data type of the reported change of the sensing measurement result may be a data type indicated by the feedback type information in the sensing reporting setup information.

In the embodiments of the present disclosure, the first trigger frame may be a newly defined trigger frame or a newly defined sensing trigger frame, which is used to implement functions of carrying the sensing reporting information or sensing a feedback poll trigger.

In some embodiments, the first trigger frame is used to trigger a transmission of the first feedback frame, and the first feedback frame may be carried and transmitted in a PPDU.

In the embodiments of the present disclosure, a carrying method of the sensing reporting setup information in the first trigger frame may be designed according to a corresponding PHY type of a PPDU transmission triggered by the first trigger frame. Taking the first trigger frame being used to trigger the transmission of PPDUs with EHT PHY and HE PHY as an example below, the carrying method of the sensing reporting setup information in the first trigger frame is illustrated. The implementation is similar for other PHY types, which is not limited in the present disclosure.

Case 1: the first trigger frame may be used to trigger a transmission of an EHT TB PPDU carrying the first feedback frame.

In some embodiments of the present disclosure, the first trigger frame includes an EHT variant common information (EHT variant Common Info) field and an EHT variant user info (EHT variant User Info) field, where the EHT variant user info field corresponds to a station device, contents indicated in the EHT variant user info field applies to the station device corresponding to the EHT variant user info field.

In some embodiments, the sensing reporting setup information is carried in the EHT variant common info field and/or the EHT variant user info field of the first trigger frame.

That is, the sensing reporting setup information may be configured according to a granularity of the sensing response device, that is, the access point device configures the corresponding sensing reporting setup information for each sensing response device, or, configures the same sensing reporting setup information for all sensing response devices. Or, a portion of the sensing reporting setup information may be configured according to the granularity of the sensing response device, and other portions of sensing reporting setup information do not distinguish the granularity of the sensing response device.

For example, the access point device can carry all the sensing reporting setup information in the EHT variant common info field. In this case, the sensing reporting setup information may be applied to all station devices (i.e., sensing response devices) corresponding to the EHT variant user info field of the first trigger frame.

For another example, the access point device may carry partial information of the sensing reporting setup information in the EHT variant common info field, and this partial sensing reporting setup information is applicable to station devices (i.e., the sensing response devices) corresponding to all EHT variant user info fields of the first trigger frame, and the access point device may carry other information of the sensing reporting setup information in the EHT variant user info field, and this other information of the sensing reporting setup information is applicable to station devices (i.e., sensing response devices) corresponding to the EHT variant user info field.

As a further example, the access point device may carry all the sensing reporting setup information in the EHT variant user info field. In this case, the sensing reporting setup information is applicable to station devices (i.e., sensing response devices) corresponding to the EHT variant user info field. For example, the sensing reporting setup information applicable to each sensing response device may be set in the EHT variant user info field corresponding to each sensing response device.

A design of a frame structure of the first trigger frame used to trigger a transmission of the EHT TB PPDU carrying the first feedback frame may be described below in combination of embodiment 1-1 and embodiment 1-2.

### Embodiment 1-1

In some embodiments of the present disclosure, the EHT variant common info field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the EHT variant common info field may include a trigger frame dependent common information field, and the field used to carry the sensing reporting setup information may be a sub-field of the trigger frame dependent common information field.

In another embodiment, the above-mentioned field used to carry the sensing reporting setup information may be a sub-field of the EHT variant common info field, that is, the above-mentioned field may be at the same level as other fields in the EHT variant common info field. A specific carrying method is not limited in the present disclosure.

In some embodiments of the present disclosure, the EHT variant user info field includes:
a threshold setting field, used to indicate a threshold that a station device corresponding to the EHT variant user information field needs to satisfy for feeding back a change of a sensing measurement result.

That is, in the embodiment 1-1, a portion of the sensing reporting setup information (for example, a threshold) may be configured based on the granularity of the sensing response device.

In some embodiments, the EHT variant user info field may include a trigger frame dependent user information field, and the threshold setting field may be a sub-field of the trigger frame dependent user information field.

In another embodiment, the threshold setting field may be a sub-field of the EHT variant user info field, that is, the threshold setting field may be at the same level as other fields in the EHT variant user info field. A specific carrying method is not limited in the present disclosure.

It should be understood that in the embodiments of the present disclosure, the names of the trigger frame dependent common information field and the trigger frame dependent user information field are only examples, which may also be replaced with other names, such as the sensing reporting field, etc., which is not limited in the present disclosure.

Optionally, in the embodiments of the present disclosure, when the EHT variant user info field does not include a threshold setting field, a station device corresponding to the EHT variant user info field may use the threshold indicated by the threshold setting field in the EHT variant common info field to perform sensing measurement reporting.

In some embodiments, the EHT variant common info field includes a field of a sensing trigger frame subtype, where the sensing trigger frame subtype is used to indicate that a subtype of the sensing trigger frame is a sensing feedback poll trigger frame. For example, when a value of the sensing trigger frame subtype field is a first value, it indicates that the first trigger frame is a sensing feedback poll trigger frame (Sensing Feedback Poll Trigger Frame).

Optionally, the first value may be any value between 0 and 15, for example, the first value may be 3.

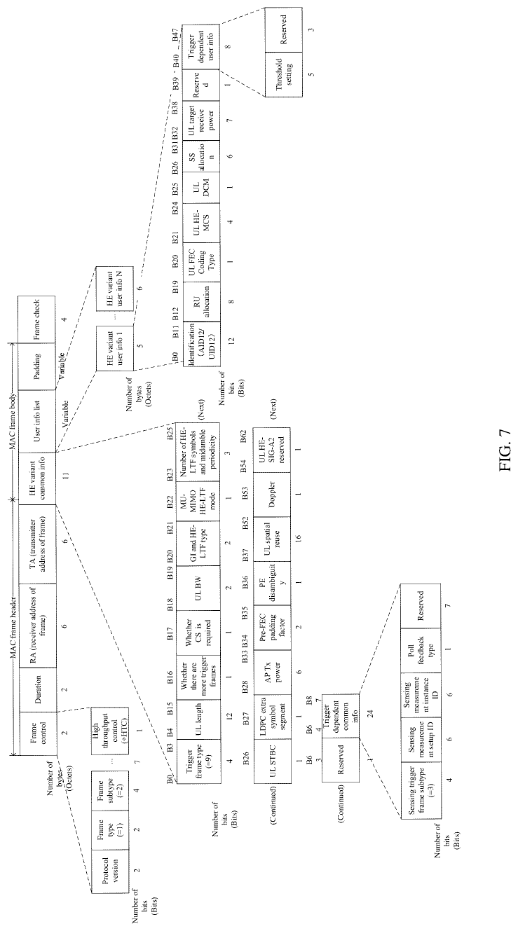

FIG. 7 is a schematic diagram of a format of a first trigger frame provided in the embodiments of the present disclosure.

It should be understood that a position and a size of each of fields in a frame format shown in FIG. 7 are only examples, which may be flexibly adjusted according to actual needs or carried content, which is not limited in the present disclosure.

As shown in FIG. 7, the first trigger frame may include an EHT variant common info field and a user info list (User Info List) field, where the user info list field includes a set of zero user information field, or sets of one or more user information fields, for example, the user info list field includes a special user info (Special User Info) field and at least one EHT variant user info field. A Content indicated by the EHT variant common info field is applicable to a station device corresponding to each user information field in the user info list field.

Furthermore, the EHT variant common info field includes a trigger frame dependent common information (Trigger Dependent Common Info) field. Optionally, a length of the trigger frame dependent common information field is a positive integer multiple of 8 bits, such as 8, 16, 24, or 32 bits. As shown in FIG. 7, 24 bits is taken as an example, which is not limited in the present disclosure.

A sensing trigger frame subtype (sensing subtype) field: configured to indicate a subtype of a sensing trigger frame.

For example, when the value of the sensing trigger frame subtype field is 3, it indicates that the first trigger frame is a sensing feedback poll trigger frame.

A sensing measurement setup ID (Measurement Setup ID) field: indicating an identity of a measurement setup.

A sensing measurement instance ID (Measurement Instance ID) field: indicating an identity of a measurement instance.

A poll feedback type (Poll Feedback Type) field: indicating a data type used to respond to a change of a sensing measurement result reported in the first feedback frame of the first trigger frame. For example, a value of 1 indicates that the data type of the reported change of the sensing measurement result is Boolean data; a value of 0 indicates that the data type of the reported change of the sensing measurement result is integer data. For another example, a value of 0 indicates that the data type of the reported change of the sensing measurement result is Boolean data; a value of 1 indicates that the data type of the reported change of the sensing measurement result is integer data.

Optionally, when there are more types of the poll feedback types, the poll feedback type field may also be other number of bits, which is not limited in the present disclosure.

In some embodiments, as shown in FIG. 7, a frame control field of the first trigger frame may further include the following fields:
a frame type (Type) field, for example, a value of the frame type field being 1 indicates that the frame is a control frame.

A frame subtype (Subtype) field, for example, a value of the frame subtype field being 2 indicates that the frame is a trigger frame.

In some embodiments, as shown in FIG. 7, the EHT variant common info field of the first trigger frame may also include the following fields:
a trigger frame type (Trigger Type) field, for example, a value of the trigger frame type field being a second value indicates that the frame is a sensing trigger frame (the second value is a reserved value, such as any value from 9 to 15 (taking 9 as an example)).

An uplink length (UL Length) field, which indicates a value of an L-SIG LENGTH field in an uplink EHT TB PPDU triggered by the sensing trigger frame.

A field about whether there are more trigger frames (More TF): indicating that whether there are other trigger frames to be sent after the trigger frame is sent. For example, a value of the field about whether there are more trigger frames being 1 represents yes, and a value being 0 represents no. For another example, a value of the field about whether there are more trigger frames being 0 represents yes, and a value being 1 represents no.

A field about whether carrier sensing is required (CS Required): indicating that a station device identified in the user information field needs to use energy detection (Energy Detection, ED) to sense a medium, and consider a state of the medium and network allocation vector (Network Allocation Vector, NAV) to determine whether to respond. For example, a value of the field about whether a CS field is required being 1 represents yes, and a value being 0 represents no. For another example, a value being 0 represents yes, and a value being 1 represents no.

An uplink bandwidth (UL BW) field: the UL BW field and an uplink bandwidth extension (UL BW Extension) field in a special user information field together indicate a bandwidth used by the EHT TB PPDU. Correspondences between values of the uplink bandwidth field and the uplink bandwidth extension field and meanings corresponding the values are shown in Table 1.

TABLE 1

| | Uplink | |
|---|---|---|
| Uplink | Bandwidth | EHT TB PPDU |
| Bandwidth | Extension | Bandwidth |
| 0 | 0 | 20 MHz |
| 0 | 1 | Reserved |
| 0 | 2 | Reserved |
| 0 | 3 | Reserved |
| 1 | 0 | 40 MHz |
| 1 | 1 | Reserved |
| 1 | 2 | Reserved |
| 1 | 3 | Reserved |
| 2 | 0 | 80 MHz |
| 2 | 1 | Reserved |
| 2 | 2 | Reserved |
| 2 | 3 | Reserved |
| 3 | 0 | Reserved |
| 3 | 1 | 160 |
| 3 | 2 | 320-1 |
| 3 | 3 | 320-2 |

GI and EHT-LTF type (GI And EHT-LTF Type) field: indicating a type of a guard interval (Guard Interval, GI) and an EHT-long training field (EHT-LTF) used by an uplink EHT TB PPDU triggered by the trigger frame.

In some embodiments, the EHT-LTF type may include but not be limited to 1×EHT-LTF, 2×EHT-LTF, or 4×EHT-LTF.

As an example but not a limitation, in time domain, a duration of 1×EHT-LTF is 3.2 as, a duration of 2×EHT-LTF is 6.4 as, and a duration of 4×EHT-LTF is 12.8 as.

As an example but not a limitation, in frequency domain, taking a bandwidth of 20 MHz as an example, subcarrier coefficients of the 1×EHT-LTF are:
EHT-LTF (20 MHz)=0, 0, 1, 0, 0, 0, +1, 0, 0, 0, +1, 0, 0, 0, 1, 0, 0, 0, +1, 0, 0, 0, 1, 0, 0, 0, +1, 0, 0, 0, +1, 0, 0, 0, +1, 0, 0, 0, +1, 0, 0, 0, 1, 0, 0, 0, 1, 0, 0, 0, +1, 0, 0, 0, +1, 0, 0, 0, +1, 0, 0, 0, 1, 0, 0, 0, 1, 0, 0, 0, 1, 0, 0, 0, +1, 0, 0, 0, 1, 0, 0, 0, 1, 0, 0, 0, +1, 0, 0, 0, +1, 0, 0, 0, 1, 0, 0, 0, 1, 0, 0, 0, +1, 0, 0, 0, 1, 0, 0, 0, 1, 0, 0, 0, +1, 0, 0, 0, 1, 0, 0, 0, 0, 0, 0, 0, 1, 0, 0, 0, +1, 0, 0, 0, +1, 0, 0, 0, +1, 0, 0, 0, +1, 0, 0, 0, +1, 0, 0, 0, +1, 0, 0, 0, 1, 0, 0, 0, 1, 0, 0, 0, 1, 0, 0, 0, 1, 0, 0, 0, 1, 0, 0, 0, +1, 0, 0, 0, 1, 0, 0, 0, 1, 0, 0, 0, 1, 0, 0, 0, +1, 0, 0, 0, 1, 0, 0, 0, 1, 0, 0, 0, +1, 0, 0, 0, 1, 0, 0, 0, 1, 0, 0, 0, +1, 0, 0, 0, 1, 0, 0, 0, +1, 0, 0, 0, 1, 0, 0, 0, 1, 0, 0, 0, 1, 0, 0, 0, 1, 0, 0, 0, 1, 0, 0.

As an example but not a limitation, subcarrier coefficients of the 2×EHT-LTF are:
EHT-LTF (20 MHz)=1, 0, 1, 0, 1, 0, +1, 0, +1, 0, 1, 0, +1, 0, 1, 0, 1, 0, 1, 0, 1, 0, +1, 0, 1, 0, +1, 0, 1, 0, 1, 0, +1, 0, +1, 0, 1, 0, +1, 0, +1, 0, +1, 0, +1, 0, +1, 0, 1, 0, +1, 0, 1, 0, +1, 0, 1, 0, 1, 0, +1, 0, +1, 0, 1, 0, +1, 0, 1, 0, 1, 0, 1, 0, 1, 0, +1, 0, 1, 0, +1, 0, +1, 0, +1, 0, 1, 0, 1, 0, +1, 0, 1, 0, 1, 0, 1, 0, 1, 0, 1, 0, +1, 0, 1, 0, 1, 0, 1, 0, +1, 0, +1, 0, +1, 0, 1, 0, 1, 0, +1, 0, 0, 0, +1, 0, 1, 0, +1, 0, +1, 0, 1, 0, +1, 0, +1, 0, 1, 0, +1, 0, +1, 0, 1, 0, 1, 0, +1, 0, 1, 0, +1, 0, +1, 0, +1, 0, +1, 0, 1, 0, +1, 0, 1, 0, +1, 0, +1, 0, 1, 0, 1, 0, +1, 0, 1, 0, 1, 0, 1, 0, 1, 0, 1, 0, +1, 0, 1, 0, +1, 0, +1, 0, 1, 0, 1, 0, +1, 0, +1, 0, 1, 0, +1, 0, 1, 0, 1, 0, 1, 0, 1, 0, +1, 0, 1, 0, +1, 0, +1, 0, +1, 0, 1, 0, 1, 0, +1, 0, 1, 0, 1, 0, 1, 0, 1, 0, 1, 0, +1, 0, 1, 0, +1.

As an example but not a limitation, subcarrier coefficients of the 4×EHT-LTF are:
EHT-LTF (20 MHz)=1, 1, +1, 1, +1, +1, +1, +1, +1, 1, +1, +1, +1, 1, 1, 1, 1, 1, +1, +1, +1, 1, +1, +1, +1, 1, +1, +1, +1, 1, 1, +1, +1, +1, +1, 1, 1, +1, +1, +1, +1, 1, 1, 1, +1, +1, +1, +1, +1, +1, 1, 1, 1, 1, +1, +1, +1, 1, 1, 1, 1, 1, 1, +1, 1, 1, 1, 1, +1, +1, 1, 1, 1, +1, +1, +1, 1, 1, 1, 1, +1, +1, 1, 1, 1, +1, +1, +1, +1, 1, 1, 1, +1, +1, +1, 1, 1, 1, +1, +1, +1, 1, 1, 1, +1, +1, +1, 1, 1, 1, +1, +1, +1.

In some embodiments, GI represents a guard interval between OFDM symbols. For example, GI may include three values: 0.8 μs, 1.6 μs, and 3.2 μs.

Taking the above three types of the EHT-LTF and the values of GI as an example, correspondences between values and meanings of the field of GI and EHT-LTF type may be shown in Table 2.

TABLE 2

| Value | Guard Interval and EHT-LTF Type |
|---|---|
| 0 | 1x EHT-LTF + 1.6 μs GI |
| 1 | 2x EHT-LTF + 1.6 μs GI |
| 2 | 4x EHT-LTF + 3.2 μs GI |
| 3 | Reserved |

Afield of number of EHT-LTF symbols (Number Of EHT-LTF Symbols): indicating a number of EHT-LTF symbols used by an uplink EHT TB PPDU triggered by the trigger frame. Correspondences between values and meanings of the field of number of EHT-LTF symbols are shown in Table 3.

TABLE 3

| Value | Number of EHT-LTF Symbols |
|---|---|
| 0 | 1 EHT-LTF |
| 1 | 2 EHT-LTF |
| 2 | 4 EHT-LTF |
| 3 | 6 EHT-LTF |
| 4 | 8 EHT-LTF |
| 5-7 | Reserved |

A field of LDPC extra symbol segment (LDPC Extra Symbol Segment): indicating a state of a low density parity check (Low Density Parity Check, LDPC) extra symbol segment. For example, the field of LDPC extra symbol segment being a value of 1 indicates that there is an LDPC extra symbol segment in an uplink EHT TB PPDU triggered by the trigger frame, and the field of LDPC extra symbol segment being a value of 0 indicates that there is no LDPC extra symbol segment in the uplink EHT TB PPDU triggered by the trigger frame.

A field of AP transmission power (AP Tx Power): indicating an AP combined transmission power of all antennas used to trigger PPDU on the transmission antenna connector. For example, the AP combined transmission power is in a unit of dBm/20 MHz.

A field of pre-FEC padding factor (Pre-FEC Padding Factor): indicating a pre-FEC padding factor of the uplink EHT TB PPDU triggered by the trigger frame. Correspondences between values and meanings of the field of pre-FEC padding factor are shown in Table 4.

TABLE 4

| Value | Pre-FEC padding factor |
|---|---|
| 0 | 4 |
| 1 | 1 |
| 2 | 2 |
| 3 | 3 |

A field of PE disambiguity (PE Disambiguity): indicating the PE disambiguity of the uplink EHT TB PPDU triggered by the trigger frame.

Afield of UL spatial reuse (UL Spatial Reuse): indicating a value of a spatial reuse field of a HE-SIG-A field of the uplink EHT TB PPDU triggered by the trigger frame.

A field of HE/EHT primary 160 MHz (HE/EHT P160): indicating that an uplink TB PPDU triggered by the trigger frame in the primary 160 MHz is a HE TB PPDU or an EHT TB PPDU. For example, a value of the field of HE/EHT primary 160 MHz being 0 indicates that the uplink TB PPDU triggered by the trigger frame in the primary 160 MHz is an EHT TB PPDU, and a value of 1 represents that an uplink TB PPDU triggered by the trigger frame in the primary 160 MHz is a HE TB PPDU.

A field of special user info field flag (Special User Info Field Flag): indicating whether a special user info field is included in the trigger frame. For example, a value of the field of special user info field flag being 0 indicates that the special user info field is included in the trigger frame, and a value of 1 indicates that the special user info field is not included in the trigger frame. The value of the above field in the EHT variant common information field being always 0 indicates that a trigger frame of the EHT variant common information field includes a special user info field.

In some embodiments of the present disclosure, as shown in FIG. 7, a user information list field of the first trigger frame may include the following fields:
a special user info (Special User Info) field: the field does not carry special user information, but carries common information expect the EHT variant common information field.

Identification (AID12) field: For example, a value of the AID12 field being a fixed value of 2007 indicates that the user information field is a special user info field.

PHY version identifier field: indicating a PHY version of the TB PPDU (except HE TB PPDU) triggered by the trigger frame. Correspondences between values and meanings of the PHY version identifier field may be shown in Table 5.

TABLE 5

| Value | PHY version identifier |
|---|---|
| 0 | EHT |
| 1-7 | Reserved |

An UL bandwidth extension (UL Bandwidth Extension) field: indicating a bandwidth of the TB PPDU obtained by the trigger frame triggering an EHT STA together with the UL bandwidth field of the EHT variant common information field, and specific values of the UL bandwidth extension field are shown in Table 1.

A field of EHT spatial reuse 1 (EHT Spatial Reuse 1): carrying a value of a field of spatial reuse 1 in a U-SIG field of the EHT TB PPDU triggered by the trigger frame.

A field of EHT spatial reuse 2 (EHT Spatial Reuse 2): carrying a value of a field of spatial reuse 2 in a U-SIG field of the EHT TB PPDU triggered by the trigger frame.

A field of U-SIG disregard and validate (U-SIG Disregard And Validate): carrying a value of a disregard and validate field in the U-SIG field of the EHT TB PPDU triggered by the trigger frame.

An EHT variant user info (EHT variant User Info) field: carrying information used for a specific STA.

An identification (AID12/UID12) field: indicating an identity of a terminal.

A resource unit allocation (RU Allocation) field: allocating information to a resource unit (resource unit, RU) of a terminal.

An uplink forward error correction coding type (UL FEC Coding Type) field: indicating a channel encoding type used by the uplink EHT TB PPDU triggered by the trigger frame. For example, a value of the field being 0 indicates BCC encoding, and a value of 1 indicates LDPC encoding.

An UL EHT modulation coding strategy (UL EHT-MCS) field: indicating a modulation coding strategy used by the uplink EHT TB PPDU triggered by the trigger frame.

A spatial stream allocation (SS Allocation) field: indicating spatial stream (spatial stream) allocation information used by the uplink EHT TB PPDU triggered by the trigger frame.

An UL target receive power (UL Target Receive Power) field: indicating an expected power of an average received signal of each antenna measured by the uplink EHT TB PPDU triggered by the trigger frame on an antenna connector of the AP.

A primary/secondary 160 MHz (PS160) field: indicating an allocation scheme of resource units with a resource unit allocation field.

A trigger frame dependent user information (Trigger Dependent User Info) field: indicating information of a STA indicated by an identification field in the EHT variant user information field where the field is located.

A threshold setting (Threshold Setting) field: indicating a measurement threshold, which may be applicable to a sensing measurement setup and a measurement instance indicated by a sensing measurement setup ID in a trigger frame dependent common information field.

Optionally, a number of bits occupied by the threshold setting field is determined according to a number of configurable thresholds (or, a granularity of the threshold setting). The more the configurable thresholds are, the more the bits occupied by the threshold setting field are. For example, when there is 20 configurable thresholds, the threshold setting field occupies 5 bits, or when there is 10 configurable thresholds, the threshold setting field occupies 4 bits. The threshold setting field occupying 5 bits is taken as an example in FIG. 7, which is not limited in the present disclosure.

Optionally, the measurement threshold may be a threshold of a change amount of a sensing measurement result, or may also be a threshold of a change rate of the sensing measurement result.

As an example, correspondences between values and meanings of the threshold setting field may be as shown in Table 6.

TABLE 6

| Value | Measurement Threshold Settings |
|---|---|
| 0 | Not using threshold-based measurement reporting |
| 1 | Reporting only if a change of a measurement |
| | result exceeds 5% |
| 2 | Reporting only if a change of a measurement |
| | result exceeds 10% |
| 3 | Reporting only if a change of a measurement |
| | result exceeds 15% |
| . . . | . . . |
| 20 | Reporting only if a change of a measurement |
| | result exceeds 100% |
| Others | Reserved |

### Embodiment 1-2

In some embodiments of the present disclosure, the EHT variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the EHT variant common info field may include a trigger frame dependent common information field, and the field used to carry the sensing reporting setup information may be a sub-field of the trigger frame dependent common information field.

It should be understood that the name of the trigger frame dependent common information field is only example, which may also be replaced with other names, such as the sensing reporting field, etc., which is not limited in the present disclosure.

In another embodiments, the above-mentioned field used to carry the sensing reporting setup information may be a sub-field of the EHT variant common info field, that is, the above-mentioned field may be at the same level as other fields in the EHT variant common info field. A specific carrying method is not limited in the present disclosure.

In some embodiments, the EHT variant common info field includes a field of a sensing trigger frame subtype, where the sensing trigger frame subtype is used to indicate that a subtype of the sensing trigger frame is a sensing feedback poll trigger frame. A specific indication method refers to the relevant description of embodiment 1-1, which may not be repeated herein for the sake of brevity.

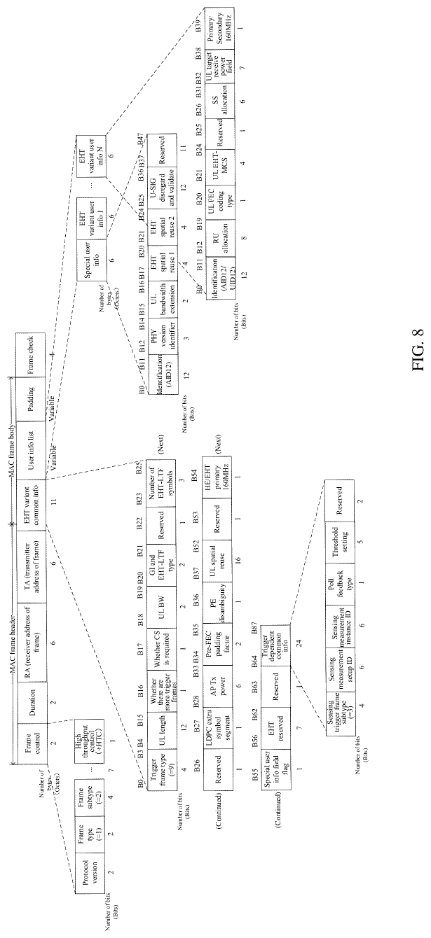

FIG. 8 is a schematic diagram of another format of a first trigger frame provided in embodiments of the present disclosure.

It should be understood that a position and a size of each of fields in a frame format shown in FIG. 8 are only examples, which may be flexibly adjusted according to actual needs or carried content, which is not limited in the present disclosure.

Different from the frame format shown in FIG. 7, all sensing reporting setup information is carried in the EHT variant common info field. In some embodiments, the EHT variant common info field includes a trigger frame dependent common information field, and the trigger frame dependent common information field includes the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device;
a threshold setting field, used to indicate a threshold that the sensing response device needs to satisfy for feeding back the change of the sensing measurement result.

Meanings of fields in FIG. 8 are the same as the meanings of the corresponding fields in the frame format shown in FIG. 7, which is not repeated herein for the sake of brevity.

Case 2: the first trigger frame may be used to trigger a transmission of a HE TB PPDU carrying the first feedback frame.

In some embodiments of the present disclosure, the first trigger frame includes an HE variant common info (HE variant Common Info) field and an HE variant user info (HE variant User Info) field, where the HE variant user info field corresponds to a station device, and contents indicated in the HE variant user info field applies to the station device corresponding to the HE variant user info field.

In some embodiments, the sensing reporting setup information is carried in the HE variant common info field and/or the HE variant user info field of the first trigger frame.

That is to say, the sensing reporting setting information can be configured according to the granularity of the sensing response device, that is, the access point device configures the corresponding sensing reporting setting information for each sensing response device, or the access point device can also configure the same sensing reporting setting information for all sensing response devices. Or part of the sensing reporting configuration information may be configured according to the sensing response device granularity, and other sensing reporting configuration information does not distinguish the sensing response device granularity.

For example, the access point device can carry all the sensing reporting setup information in the HE variant common info field. In this case, the sensing reporting setup information may be applied to all station devices (i.e., sensing response devices) corresponding to the HE variant user info field of the first trigger frame.

For another example, the access point device may carry partial information of the sensing reporting setup information in the HE variant common info field, and this partial sensing reporting setup information is applicable to station devices (i.e., the sensing response devices) corresponding to all HE variant user info fields of the first trigger frame, and the access point device may carry other information of the sensing reporting setup information in the HE variant user info field, and this other information of the sensing reporting setup information is applicable to station devices (i.e., sensing response devices) corresponding to the HE variant user Info field.

As a further example, the access point device may carry all the sensing reporting setup information in the HE variant user info field. In this case, the sensing reporting setup information is applicable to station devices (i.e., sensing response devices) corresponding to the HE variant user info field. For example, the sensing reporting setup information applicable to each sensing response device may be set in the HE variant user info field corresponding to each sensing response device.

A design of a frame structure of the first trigger frame used to trigger a transmission of the HE TB PPDU carrying the first feedback frame may be described below in combination of embodiment 1-3 and embodiment 1-4.

### Embodiment 1-3

In some embodiments of the present disclosure, the HE variant common info field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the HE variant common info field may include a trigger frame dependent common information field, and the field used to carry the sensing reporting setup information may be a sub-field of the trigger frame dependent common information field.

In another embodiments, the above-mentioned field used to carry the sensing reporting setup information may be a sub-field of the HE variant common info field, that is, the above-mentioned field may be at the same level as other fields in the HE variant common info field. A specific carrying method is not limited in the present disclosure.

In some embodiments, the HE variant user info field includes:
a threshold setting field, used to indicate a threshold that a station device corresponding to the HE variant user information field needs to satisfy for feeding back a change of a sensing measurement result.

That is, in the embodiment 1-3, a portion of the sensing reporting setup information (for example, a threshold) may be configured based on the granularity of the sensing response device.

In some embodiments, the HE variant user info field may include a trigger frame dependent user information field, and the threshold setting field may be a sub-field of the trigger frame dependent user information field.

In another embodiments, the above-mentioned threshold setting field may be a sub-field of the HE variant user info field, that is, the threshold setting field may be at the same level as other fields in the HE variant user info field. A specific carrying method is not limited in the present disclosure.

It should be understood that in the embodiments of the present disclosure, the names of the trigger frame dependent common information field and the trigger frame dependent user information field are only examples, which may also be replaced with other names, such as the sensing reporting field, etc., which is not limited in the present disclosure.

Optionally, in the embodiments of the present disclosure, when the HE variant user info field does not include a threshold setting field, a station device corresponding to the HE variant user info field may use the threshold indicated by the threshold setting field in the HE variant common info field to perform sensing measurement reporting.

In some embodiments, the HE variant common info field includes a field of a sensing trigger frame subtype, where the sensing trigger frame subtype is used to indicate that a subtype of the sensing trigger frame is a sensing feedback poll trigger frame. A specific indication method refers to the relevant description of embodiment 1-1, which may not be repeated herein for the sake of brevity.

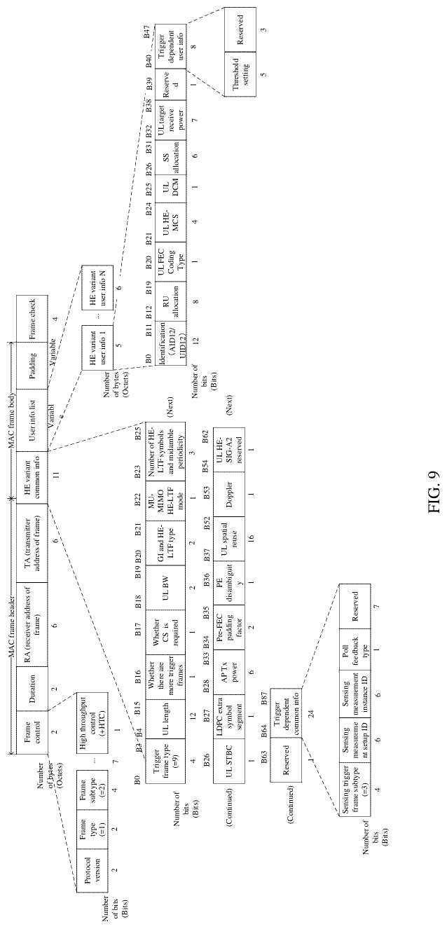

FIG. 9 is a schematic diagram of a format of a first trigger frame provided in embodiments of the present disclosure.

It should be understood that a position and a size of each of fields in a frame format shown in FIG. 9 are only examples, which may be flexibly adjusted according to actual needs or carried content, which is not limited in the present disclosure.

As shown in FIG. 9, the first trigger frame may include an HE variant common info field and a user info list field, where the user info list field includes zero HE variant user info field, or one or more HE variant user info fields. A content indicated by the HE variant common info field is applicable to a station device corresponding to each HE variant user info field in the user info field.

Furthermore, the HE variant common info field includes a trigger frame dependent common information (Trigger Dependent Common Info) field. Optionally, a length of the trigger frame dependent common information field is a positive integer multiple of 8 bits, such as 8, 16, 24, or 32 bits. As shown in FIG. 9, 24 bits is taken as an example, which is not limited in the present disclosure.

A sensing trigger frame subtype (sensing subtype) field: configured to indicate a subtype of a sensing trigger frame.

For example, when a value of the sensing trigger frame subtype field is 3, it indicates that the first trigger frame is a sensing feedback poll trigger frame (Sensing Feedback Poll Trigger Frame).

A sensing measurement setup ID (Measurement Setup ID) field: indicating an identity of a measurement setup.

A sensing measurement instance ID (Measurement Instance ID) field: indicating an identity of a measurement instance.

A poll feedback type (Poll Feedback Type) field: indicating a data type used to respond to a change of a sensing measurement result reported in the first feedback frame of the first trigger frame. For example, a value of 1 indicates that the data type of the reported change of the sensing measurement result is Boolean data; a value of 0 indicates that the data type of the reported change of the sensing measurement result is integer data. For another example, a value of 0 indicates that the data type of the reported change of the sensing measurement result is Boolean data; a value of 1 indicates that the data type of the reported change of the sensing measurement result is integer data.

Optionally, when there are more types of the poll feedback types, the poll feedback type field may also be other number of bits, which is not limited in the present disclosure.

In some embodiments of the present disclosure, as shown in FIG. 9, a frame control field of the first trigger frame may further include the following fields:
a frame type (Type) field, for example, a value of the frame type field being 1 indicates that the frame is a control frame.

A frame subtype (Subtype) field, for example, a value of the frame subtype field being 2 indicates that the frame is a trigger frame.

In some embodiments of the present disclosure, as shown in FIG. 9, the HE variant common info field of the first trigger frame may further include the following fields: a trigger type (Trigger Type) field, for example, a value of the trigger frame type field being a second value indicates that the frame is a sensing trigger frame (the second value is a reserved value, such as any value from 9 to 15 (taking 9 as an example)).

A uplink length (UL Length) field, which indicates a value of an L-SIG LENGTH field in an uplink HE TB PPDU triggered by the sensing trigger frame.

A field about whether there are more trigger frames (More TF): indicating whether there are other trigger frames to be sent after the trigger frame is sent. For example, a value of the field about whether there are more trigger frames being 1 represents yes, and a value being 0 represents no. For another example, a value of the field about whether there are more trigger frames being 0 represents yes, and a value being 1 represents no.

An uplink bandwidth (UL BW) field: indicating a bandwidth used by the uplink HE TB PPDU triggered by the trigger frame. Correspondences between values and meanings of the UL bandwidth field are shown in Table 7.

TABLE 7
shows encoding meanings of the UL BW field

| Value | Uplink Bandwidth |
|---|---|
| 0 | 20 MHz |
| 1 | 40 MHz |
| 2 | 80 MHz |
| 3 | 80 + 80 MH or 160 MHz |

GI and HE-LTF type (GI And HE-LTF Type) field: indicating a type of a guard interval (Guard Interval, GI) and a HE-long training field (EHT-LTF) used by an uplink HE TB PPDU triggered by the trigger frame. Correspondences between values and meanings of the field of GI and HE-LTF type may be shown in Table 8.

TABLE 8
meanings of the field of GI and HE-LTF type

| Value | Guard Interval and HE-LTF Type |
|---|---|
| 0 | 1x HE-LTF + 1.6 μs GI |
| 1 | 2x HE-LTF + 1.6 μs GI |
| 2 | 4x HE-LTF + 3.2 μs GI |
| 3 | Reserved |

MU-MIMO HE-LTF mode field: When the field of GI and HE-LTF indicates 2× HE-LTF+1.6 μs GI or 4×HE-LTF+3.2 μs, the field indicates using all bandwidth resources, and is allocated to HE-LTF modes used by HE TB PPDU of multiple non-AP STAs. In addition, this field is used to indicate a single stream pilot HE-LTF mode. Correspondences between values and meanings of the MU-MIMO HE-LTF mode field are shown in Table 9.

TABLE 9
meanings of the MU-MIMO HE-LTF mode field

| Value | MU-MIMO HE-LTF mode |
|---|---|
| 0 | HE single stream pilot HE-LTF mode |
| 1 | HE masked HE-LTF sequence mode |

Afield of number of HE-LTF symbols and midamble periodicity (Number Of HE-LTF Symbols And Midamble Periodicity): When a Doppler field is 0, the field indicates a number of HE-LTF symbols used by the uplink HE TB PPDU triggered by the trigger frame. Correspondences between values and meanings of the field of number of HE-LTF symbols are shown in Table 10.

TABLE 10
meanings of the field of number of HE-LTF symbols

| Value | Number of HE-LTF symbols |
|---|---|
| 0 | 1 HE-LTF |
| 1 | 2 HE-LTF |
| 2 | 4 HE-LTF |
| 3 | 6 HE-LTF |
| 4 | 8 HE-LTF |
| 5-7 | Reserved |

When a Doppler field is 1, the field indicates a number of HE-LTF symbols and midamble periodicity used by the uplink HE TB PPDU triggered by the trigger frame.

TABLE 11
meanings of the field of number of HE-
LTF symbol and midamble periodicity

| Value | Number of HE-LTF Symbols and Midamble Periodicity |
|---|---|
| 0 | 1 HE-LTF and 10 symbol periodicities |
| 1 | 2 HE-LTF and 10 symbol periodicities |
| 2 | 4 HE-LTF and 10 symbol periodicities |
| 4 | 1 HE-LTF and 20 symbol periodicities |
| 5 | 2 HE-LTF and 20 symbol periodicities |
| 6 | 4 HE-LTF and 20 symbol periodicities |
| 3, 7 | Reserved |

UL space time block coding (UL Space Time Block Coding, UL STBC) field: indicating that whether the HE TB PPDU triggered by the trigger frame uses space time block coding. For example, a value of the field being 1 indicates using space time block coding, and a value of the field being 0 indicates not using space time block coding.

A field of LDPC extra symbol segment (LDPC Extra Symbol Segment): indicating a state of a low density parity check (Low Density Parity Check, LDPC) extra symbol segment. For example, the field of LDPC extra symbol segment being a value of 1 indicates that there is an LDPC extra symbol segment in an uplink HE TB PPDU triggered by the trigger frame, and the field of LDPC extra symbol segment being a value of 0 indicates that there is no LDPC extra symbol segment in the uplink HE TB PPDU triggered by the trigger frame.

A field of AP transmission power (AP Tx Power): indicating an AP combined transmission power of all antennas used to trigger PPDU on the transmission antenna connector. For example, the AP combined transmission power is in a unit of dBm/20 MHz.

A field of pre-FEC padding factor (Pre-FEC Padding Factor): indicating a pre-FEC padding factor of the uplink HE TB PPDU triggered by the trigger frame. Correspondences between values and meanings of the field of pre-FEC padding factor are shown in Table 12.

TABLE 12
meanings of the field of pre-FEC padding factor

| Value | Pre-FEC Padding Factor |
|---|---|
| 0 | 4 |
| 1 | 1 |
| 2 | 2 |
| 3 | 3 |

A field of PE disambiguity (PE Disambiguity): indicating the PE disambiguity of the uplink HE TB PPDU triggered by the trigger frame.

Afield of UL spatial reuse (UL Spatial Reuse): indicating a value of a spatial reuse field of a HE-SIG-A field of the uplink HE TB PPDU triggered by the trigger frame.

A Doppler (Doppler) field: indicating whether there is a midamble in the HE TB PPDU triggered by this trigger frame. For example, a value of the field being 1 represents a midamble existing, and a value of the field being 0 means the midamble not existing.

An UL HE-SIG-A2 reserved (UL HE-SIG-A2 Reserved) field: carrying a value of a reserved field in a HE-SIG-A2 subdomain of the HE TB PPDU triggered by the trigger frame. Values of the UL HE-SIG-A2 reserved fields are all set as 1.

In some embodiments of the present disclosure, as shown in FIG. 9, the user info list field of the first trigger frame may include the following fields:
an HE variant user info (HE variant User Info) field: carrying information used for a specific STA.

An identification (AID12/UID12) field: indicating an identity of a terminal.

A resource unit allocation (RU Allocation) field: allocating information to a resource unit (resource unit, RU) of a terminal.

An uplink forward error correction coding type (UL FEC Coding Type) field: indicating a channel encoding type used by the uplink HE TB PPDU triggered by the trigger frame. For example, a value of the field being 0 indicates BCC encoding, and a value of 1 indicates LDPC encoding.

An UL HE modulation coding strategy (UL HE-MCS) field: indicating a modulation coding strategy used by the uplink HE TB PPDU triggered by the trigger frame.

An UL dual carrier modulation (UL DCM) field: indicating whether the HE TB PPDU triggered by the trigger frame uses dual carrier modulation, for example, a value of the field being 1 indicates using dual carrier modulation and a value of the field being 0 indicates not using dual carrier modulation.

A spatial stream allocation (SS Allocation) field: indicating spatial stream (spatial stream) allocation information used by the uplink HE TB PPDU triggered by the trigger frame.

An UL target receive power (UL Target Receive Power) field: indicating an expected power of an average received signal of each antenna measured by the uplink HE TB PPDU triggered by the trigger frame on an antenna connector of the AP.

A trigger frame dependent user information (Trigger Dependent User Info) field: indicating information of a STA indicated by an identification field in the HE variant user information field where the field is located.

A threshold setting (Threshold Setting) field: indicating a measurement threshold, which may be applicable to a sensing measurement setup and a measurement instance indicated by a sensing measurement setup ID in a trigger frame dependent common information field.

Optionally, a number of bits occupied by the threshold setting field is determined according to a number of configurable thresholds (or, a granularity of the threshold setting). The more the configurable thresholds are, the more the bits occupied by the threshold setting field are. For example, when there is 20 configurable thresholds, the threshold setting field occupies 5 bits, or when there is 10 configurable thresholds, the threshold setting field occupies 4 bits. The threshold setting field occupying 5 bits is taken as an example in FIG. 7, which is not limited in the present disclosure.

Optionally, the measurement threshold may be a threshold of a change amount of a sensing measurement result, or may also be a threshold of a change rate of the sensing measurement result.

Optionally, correspondences between values and meanings of the threshold setting field may be shown in the above-mentioned Table 6.

### Embodiment 1-4

In some embodiments of this application, the HE variant general information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the HE variant common info field may include a trigger frame dependent common information field, and the field used to carry the sensing reporting setup information may be a sub-field of the trigger frame dependent common information field.

It should be understood that the name of the trigger frame dependent common information field is only example, which may also be replaced with other names, such as the sensing reporting field, etc., which is not limited in the present disclosure.

In another embodiments, the above-mentioned field used to carry the sensing reporting setup information may be a sub-field of the HE variant common info field, that is, the above-mentioned field may be at the same level as other fields in the HE variant common info field. A specific carrying method is not limited in the present disclosure.

In some embodiments, the HE variant common info field includes a field of a sensing trigger frame subtype, where the sensing trigger frame subtype is used to indicate that a subtype of the sensing trigger frame is a sensing feedback poll trigger frame. A specific indication method refers to the relevant description of embodiment 1-1, which may not be repeated herein for the sake of brevity.

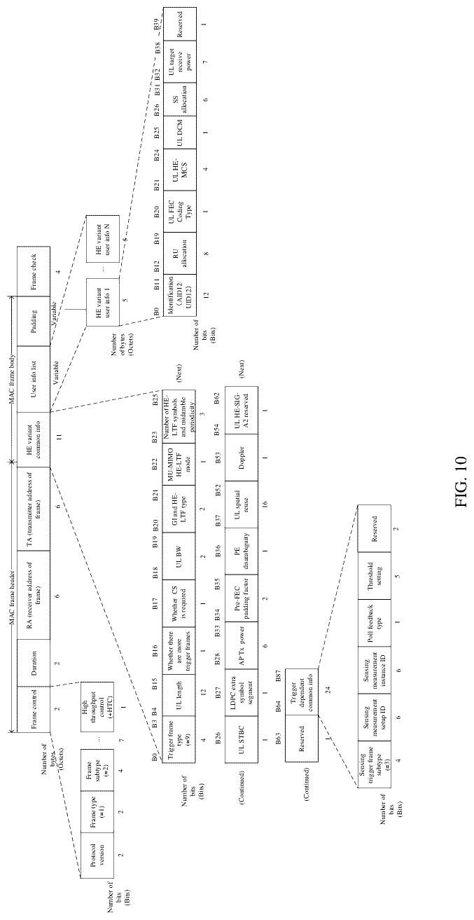

FIG. 10 is a schematic diagram of another format of a first trigger frame provided in the embodiments of the present disclosure.

It should be understood that a position and a size of each of fields in a frame format shown in FIG. 10 are only examples, which may be flexibly adjusted according to actual needs or carried content, which is not limited in the present disclosure.

Different from the frame format shown in FIG. 9, all sensing reporting setup information is carried in the HE variant common info field. In some embodiments, the HE variant common info field includes a trigger frame dependent common information field, and the trigger frame dependent common information field includes the following fields:
a measurement instance identity field, used to indicate an identity of a measurement instance;
a measurement setup identity field, used to indicate an identity of measurement setup; a feedback type information field, used to indicate a data type of a change of a sensing measurement result fed back by the sensing response device;
a threshold setting field, used to indicate a threshold that the sensing response device needs to satisfy for feeding back the change of the sensing measurement result.

Meanings of fields in FIG. 10 are the same as the meanings of the corresponding fields in the frame format shown in FIG. 9, which is not repeated herein for the sake of brevity.

### Embodiment 2

In some embodiments of the present disclosure, an access point device receives a first feedback frame sent by at least one sensing response device, where the first feedback frame includes sensing reporting information. Optionally, the access point device may determine to trigger a target sensing response device for sensing measurement reporting according to the sensing reporting information.

In the embodiments of the present disclosure, the first feedback frame may also referred to as a sensing feedback frame, or may also be replaced with other similar names, and a specific name of the first feedback frame may not be limited in the present disclosure.

In an embodiment, the sensing reporting information further includes at least one of the following:
a measurement instance identity, used to identify a measurement instance;
a measurement setup identity, used to identify measurement setup for performing the measurement instance indicated by the measurement instance identity;
feedback type information (or referred to as poll feedback type information), used to indicate a data type of a change of a sensing measurement result fed back by the sensing response device;
threshold setting information, used to indicate a threshold of the sensing response device being used to feed back the change of the sensing measurement result; or
information of the change of the sensing measurement result, used to indicate the change of the sensing measurement result fed back by the sensing response device.

In some embodiments, the measurement instance identity may indicate a measurement instance that has been performed. Optionally, the measurement instance identity in the first feedback frame may be the same as the measurement instance identity indicated in the first trigger frame.

In some embodiments, the measurement setup identity may indicate a measurement setup used to perform a performed measurement instance. Optionally, the measurement setup identity in the first feedback frame may be the same as the measurement setup identity indicated in the first trigger frame.

In some embodiments, the feedback type information may indicate that the data type of the change in the perception measurement result fed back by the perception response device is Boolean data, for example, indicating whether the change in the perception measurement result is greater than a threshold, or it may also indicate the perception measurement result fed back by the perception response device. The data type of the result change is integer data, for example, a specific numerical value indicating the change in the sensory measurement result.

Optionally, the feedback type information indicated in the first feedback frame may be the same as the feedback type information indicated in the first trigger frame.

In some embodiments, the change in the perception measurement result may refer to the change rate of the perception measurement result of this measurement instance relative to the perception measurement result of the previous measurement instance (for example, 15%, 50%, etc.), or it may also refer to this measurement The change amount of the perceptual measurement result of the instance relative to the perceptual measurement result of the previous measurement instance, where this measurement instance may refer to the measurement instance indicated by the measurement instance identifier in the perceptual reporting setting information. This application is concerned with the change of the perceptual measurement result. The characterization method is not limited. In the following description, the change in the perceived measurement result is represented by the change rate of the measurement result as an example. However, the application is not limited thereto.

Therefore, in the embodiments of the present disclosure, the access point device may determine to trigger the target sensing response device that performs the sensing measurement reporting according to the sensing reporting information in the first feedback frame. For example, the target sensing response device may be a sensing response device whose reported information of a change of a sensing measurement result is greater than a corresponding threshold, or the target sensing response device may be a sensing response device whose change of the sensing measurement result indicated by the feedback type information is greater than the threshold. Further, the access point device may trigger the target sensing response device to perform sensing measurement reporting.

In some embodiments of the present disclosure, the first feedback frame includes at least one of the following fields:
a measurement instance identity (also referred to as a sensing measurement instance identity) field, used to indicate an identity of a measurement instance;
a measurement setup identity (also referred to as a sensing measurement setup identity) field, used to indicate an identity of a measurement setup;
feedback type information (or referred to as poll feedback type information) field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

A design for a frame structure of the first feedback frame is described in combination of some embodiments below.

### Embodiment 2-1: The First Feedback Frame is an Action Frame

That is, a function of feeding back the sensing reporting information may be realized through the action frame.

In some embodiments, an existing action frame type (e.g., a public action frame type) may be used to carry the sensing reporting information, or an action frame type (e.g., a protected sensing action frame type) may be newly added to carry the sensing reporting information.

For example, a public action frame may be used to carry the sensing reporting information.

For another example, a sensing action frame may be defined, and the defined sensing action frame is used to carry the sensing reporting information.

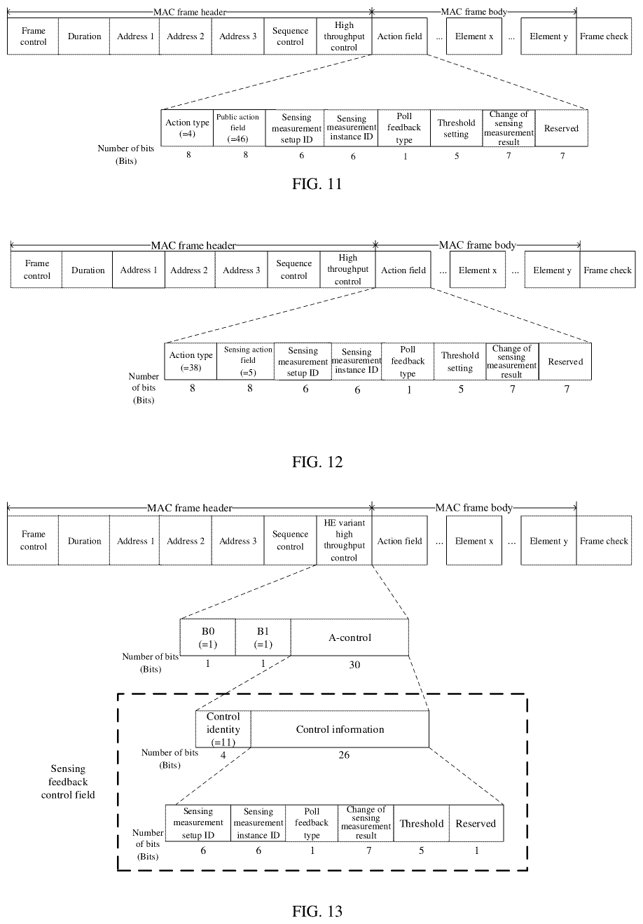

FIG. 11 shows a schematic diagram of a format of a first feedback frame implemented through a public action frame provided in the present disclosure. It should be understood that a position and a size of each of fields in a frame format shown in FIG. 11 are only examples, which may be flexibly adjusted according to actual needs or carried content, which is not limited in the present disclosure.

As shown in FIG. 11, a field of an action field (Action field) of the first feedback frame includes the following fields:
an action category (Category) field, for example, a value of the field being 4 indicates that a corresponding action frame is a public action frame (Public Action Frame);
a field of public action field (Public Action Field), for example, a value of the field being a reserved value (any value from 46 to 255, and taking 46 as an example) indicates that the public action frame is a sensing feedback frame.

Further, the field of the action field also includes the following fields:
a sensing measurement instance ID field, used to indicate an identity of a measurement instance;
a sensing measurement setup ID field, used to indicate an identity of a measurement setup;
a poll feedback type field, used to indicate a data type of a change of a sensing measurement result fed back by the sensing response device;
a threshold setting field, used to indicate a threshold of the sensing response device being used to feed back the change of the sensing measurement result;
a field of the change of the sensing measurement result, used to indicate the change of the sensing measurement result fed back by the sensing response device.

For example, the field of the change of the sensing measurement result is used to indicate a change of a measurement result of a measurement instance identified by the sensing measurement setup ID and the sensing measurement instance ID compared to a measurement result of a previous measurement instance.

Optionally, a meaning of the field of the change of the sensing measurement result depends on a definition of the poll feedback type field.

For example, when the poll feedback type field indicates that a data type is an integer type (for example, a value of the field is 0), the field of the change of the sensing measurement result may indicate a specific value of a change rate of the measurement result, and when the poll feedback type field indicates that the data type is Boolean (for example, when the value of the field is 1), the field of the change of the sensing measurement result indicates a relative size of the change rate of the measurement result and the threshold.

Optionally, a length of the field of the change of the sensing measurement result may be determined according to the meaning of the poll feedback type field.

For example, when the poll feedback type field indicates that the data type is an integer type (for example, a value of the field is 0), the length of the field of the change of the sensing measurement result may be determined according to an optional value range of a change rate.

For example, when the optional value range of the change rate is 100, the field of the change of the sensing measurement result may be 7 bits, or, when the optional value range of the change rate is 10, the field of the change of the sensing measurement result may be 4 bits. It is taken as an example below that the field of the change of the sensing measurement result is 7 bits, which is not limited in the present disclosure.

For another example, when the poll feedback type field indicates that the data type is Boolean (for example, the value of the field is 1), the field of the change of the sensing measurement result may be 1 bit.

As an example, correspondences between values and meanings of the field of the change of the sensing measurement result may be shown in Table 13.

TABLE 13

| Value | Change of a Sensing Measurement Result |
|---|---|
| 0 | A change rate with a value of 0.00 |
| 1 | A change rate with a value of 0.01 |
| 2 | A change rate with a value of 0.02 |
| . . . | . . . |
| 99 | A change rate with a value of 0.99 |
| 100 | A change rate with a value of 1.00 |
| 101-125 | Reserved |
| 126 | A change rate is less than a threshold |
| 127 | A change rate is greater than or equal |
| | to a threshold |

For Table 13, the access point device may interpret contents indicated by the field of the change of the sensing measurement result according to a value of the poll feedback type field. For example, when the poll feedback type field indicates that the data type is an integer type (for example, the value of the field is 0), a value range of the field of the change of the sensing measurement result is [0,100], indicating 100 specific values of the change rate of the measurement result. Optionally, if an actual change rate is greater than 1, a value of the field of the change of the sensing measurement result is 100. When the poll feedback type field indicates that the data type is Boolean (for example, the value of the field is 1), the value range of the field of the change of the sensing measurement result is [126, 127], where a value of 126 indicates that the change rate of the measurement result is less than the threshold, and the value of 127 indicates that the change rate of the measurement result is greater than or equal to the threshold.

As another example, when the poll feedback type field indicates that the data type is Boolean (for example, the value of the field is 0), correspondences between values and meanings of the field of the change of the sensing measurement result may be as shown in Table 14.

TABLE 14
meanings of the field of the change
of the sensing measurement result

| Value | Change of a Sensing Measurement Result |
|---|---|
| 0 | A change rate with a value of 0.00 |
| 1 | A change rate with a value of 0.01 |
| 2 | A change rate with a value of 0.02 |
| . . . | . . . |
| 99 | A change rate with a value of 0.99 |
| 100 | A change rate with a value of 0.00 |
| 101-127 | Reserved |

That is, a value range of the field of the change of the sensing measurement result is [0,100], thereby indicating 100 specific values of change rates of measurement results.

Optionally, if an actual change rate is greater than 1, a value of the field of the change of the sensing measurement result is 100.

As another example, when the poll feedback type field indicates that the data type is Boolean (for example, the value of the field is 1), correspondences between values and meanings of the field of the change of the sensing measurement result may be as shown in Table 15.

TABLE 15

| Value | Change of a Sensing Measurement Result |
|---|---|
| 0 | A change rate is less than a threshold |
| 1 | A change rate is greater than or equal |
| | to a threshold |

That is, the value range of the change of the sensing measurement result is [0,1], where a value of 0 indicates that the change rate of the measurement result is less than the threshold, and a value of 1 indicates that the change rate of the measurement result is greater than or equal to the threshold.

FIG. 12 is a schematic diagram of a format of a first feedback frame implemented through a newly defined sensing action frame provided by the embodiments of the present disclosure. It should be understood that a position and a size of each of fields in a frame format shown in FIG. 12 are only examples, which may be flexibly adjusted according to actual needs or carried content, which is not limited in the present disclosure.

As shown in FIG. 12, a field an action field (Action field) of the first feedback frame includes the following fields:
an action category (Category) field, for example, a value of the field being a third value indicates that the action frame is a newly defined protected sensing action frame (Protected Sensing Action Frame), where the third value is a reserved value, such as 38;
a field of a sensing action field (Sensing Action Field), for example, a value of the field being a fourth value (any value from 0-255, and taking 5 as an example) indicates that the action frame is a Sensing feedback frame (Sensing Feedback frame).

Further, the field of the first feedback frame action field (Action field) also includes the following fields:
a sensing measurement instance ID field, used to indicate an identity of a measurement instance;
a sensing measurement setup ID field, used to indicate an identity of a measurement setup;
a poll feedback type field, used to indicate a data type of a change of a sensing measurement result fed back by the sensing response device;
a threshold setting field, used to indicate a threshold of the sensing response device being used to feed back the change of the sensing measurement result;
a field of the change of the sensing measurement result, used to indicate the change of the sensing measurement result fed back by the sensing response device.

### Embodiment 2-2: Sensing Reporting Information is Carried Through an Aggregation Control (Aggregation Control, A-Control) Field

Optionally, the first feedback frame may be any frame including an A-Control field, such as a data frame or a management frame.

As an example, the first feedback frame may be a quality of service null data (Quality of Service Null Data, QoS-Null-Data) frame, a quality of service (Quality of Service Data, QoS) frame, or a control frame wrapped by a control wrapper (Control Wrapper) frame, etc.

In some embodiments, the A-Control field includes a control identity (ID) field and a control information (Control Information) field, where the control ID field is used to indicate that the control information field is used to carry the sensing reporting information, and the control information field is used to carry place the sensing reporting information.

Optionally, a value of the control ID field is a fifth value, and the fifth value may be a reserved value, such as 9, or any value from 11 to 15. The fifth value being 11 is taken as an example for explanation below, but the present disclosure is not limited thereto. That is, by newly defining a control ID, a corresponding control information field is further used to carry a new information type (i.e., the sensing reporting information).

In some embodiments, the control information field may include at least one of the following fields:
a sensing measurement instance ID field, used to indicate an identity of a measurement instance;
a sensing measurement setup ID field, used to indicate an identity of a measurement setup;
a poll feedback type field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the control identity (ID) field and the control information field may be considered as sensing feedback control fields.

In some embodiments, the sensing feedback control fields may be included in a HE variant high throughput control field of the first feedback frame.

FIG. 13 is a schematic diagram of a format of a first feedback frame including an A-Control field provided in the embodiments of the present disclosure. It should be understood that a position and a size of each of fields in a frame format shown in FIG. 13 are only examples, which may be flexibly adjusted according to actual needs or carried content, which is not limited in the present disclosure.

As shown in FIG. 13, the first feedback frame includes a high throughput control field. The high throughput control field includes a B0 field, a B1 field and an A-Control field. For example, values of the B0 field and the B1 field being both 1 indicates that the high throughput control field is a HE variant high throughput control field, and a sensing feedback control field is carried in the A-Control field.

Further, the A-Control field includes a control ID field and a control information field. A value of the control ID field being 11 indicates that a corresponding control information field is used to carry sensing reporting information.

For example, as shown in FIG. 13, the control information field includes the following fields:
a sensing measurement instance ID field, used to indicate an identity of a measurement instance;
a sensing measurement setup ID field, used to indicate an identity of a measurement setup;
a poll feedback type field, used to indicate a data type of a change of a sensing measurement result fed back by the sensing response device;
a threshold setting field, used to indicate a threshold of the sensing response device being used to feed back the change of the sensing measurement result;
a field of the change of the sensing measurement result, used to indicate the change of the sensing measurement result fed back by the sensing response device.

An implementation of above various fields refers to the relevant description of embodiment 1-3, which may not be repeated herein for the sake of brevity.

In summary, a process of the trigger based sensing measurement reporting can be implemented by designing the frame structure of the sensing feedback poll trigger frame and the sensing feedback frame in the sensing reporting phase in the embodiments of the present disclosure. Further, for two typical PHY versions, frame structure variants suitable for EHT PHY and HE PHY are designed, which can meet the measurement needs for application scenarios of different PHY versions.

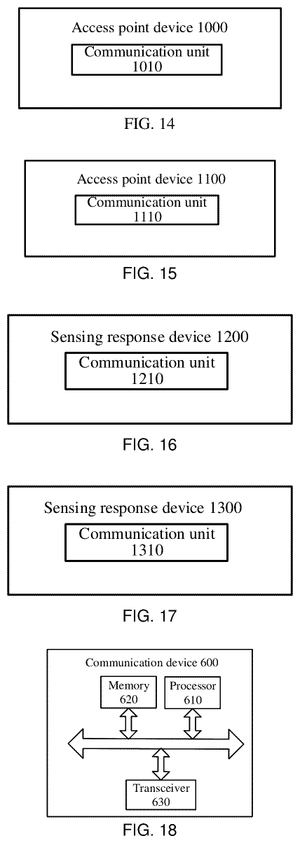

The embodiments of methods of the present disclosure is described in detail above in combination with FIGS. 6 to 13, and embodiments of apparatuses of the present disclosure is described in detail below in combination with FIGS. 14 to 20. It should be understood that the embodiments of apparatuses correspond to the embodiments of methods, and similar descriptions may refer to the descriptions of embodiments of methods.

FIG. 14 is a block diagram of an access point device according to the embodiments of the present disclosure. The access point device 1000 in FIG. 14 includes:
a communication unit 1010, configured to send a first trigger frame to at least one sensing response device, the first trigger frame including sensing reporting setup information, the sensing reporting setup information being used to determine a target sensing response device for sensing measurement reporting in the at least one sensing response device.

In some embodiments, the sensing reporting setup information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device; or
threshold setting information, used to indicate a threshold that the sensing response device needs to satisfy for feeding back the change of the sensing measurement result.

In some embodiments, the first trigger frame includes an extremely high throughput (EHT) variant common information field and an EHT variant user information field, and the sensing reporting setup information is carried in the EHT variant common information field and/or the EHT variant user information field.

In some embodiments, the EHT variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the EHT variant common information field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the EHT variant user information field includes:
a threshold setting field, used to indicate a threshold that a station device corresponding to the EHT variant user information field needs to satisfy for feeding back a change of a sensing measurement result.

In some embodiments, the EHT variant common information field includes a field of a sensing trigger frame subtype, and the sensing trigger frame subtype is used to indicate a subtype of a sensing trigger frame being a sensing feedback poll trigger frame.

In some embodiments, the first trigger frame includes a high efficiency (HE) variant common information field and a HE variant user information field, and the sensing reporting setup information is carried in the HE variant common information field and/or the HE variant user information field.

In some embodiments, the HE variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the HE variant common information field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the HE variant user information field includes:
a threshold setting field, used to indicate a threshold that a station device corresponding to the HE variant user information field needs to satisfy for feeding back a change of a sensing measurement result.

In some embodiments, the HE variant common information field includes a field of a sensing trigger frame subtype, and the sensing trigger frame subtype is used to indicate a subtype of a sensing trigger frame being a sensing feedback poll trigger frame.

In some embodiments, the communication unit 1010 is further configured to:
receive a first feedback frame sent by at least one sensing response device, where the first feedback frame includes sensing reporting information.

In some embodiments, the sensing reporting information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device;
threshold setting information, used to indicate a threshold of the sensing response device being used to feed back the change of the sensing measurement result; or
information of the change of the sensing measurement result, used to indicate the change of the sensing measurement result fed back by the sensing response device.

In some embodiments, the first feedback frame is an action frame.

In some embodiments, the first feedback frame is a public action frame or a sensing action frame.

In some embodiments, the first feedback frame includes at least one of the following fields:
a measurement instance identity field, used to indicate an identity of a measurement instance;
a measurement setup identity field, used to indicate an identity of measurement setup; a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a public action frame, the first feedback frame includes an action type field and a public action field, the action type field is used to indicate that the action frame is a public action frame, and a value of the public action domain field being a reserved value is used to indicate that the public action frame is a sensing feedback frame.

In some embodiments, the first feedback frame is a sensing action frame, the first feedback frame includes an action type field and a sensing action field, and a value of the action type field being a reserved value is used to indicate that the action frame is a sensing action frame, and the sensing action field is used to indicate that the sensing action frame is a sensing feedback frame.

In some embodiments, the first feedback frame includes an aggregation control (A-Control) field, and the sensing reporting information is carried in the A-Control field.

In some embodiments, the A-Control field includes a control identity field and a control information field, where the control identity field is used to indicate that the control information field is used to carry the sensing reporting information, and the control information field is used to carry the sensing reporting information.

In some embodiments, the control information field includes at least one of the following:
a measurement instance identity field, used to indicate an identity of a measurement instance;
a measurement setup identity field, used to indicate an identity of measurement setup; a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a data frame or a management frame.

Optionally, in some embodiments, the above-mentioned communication unit may be a communication interface or transceiver, or an input/output interface of a communication chip or a system on a chip.

It should be understood that the access point device 1000 according to the embodiments of the present disclosure may correspond to the access point device in the embodiments of methods of the present disclosure, and the above and other operations and/or functions of various units in the access point device 1000 are aimed to implement corresponding processes of the access point device in the method 200 shown in FIGS. 6-13, which may not be repeated herein for the sake of brevity.

FIG. 15 is a schematic block diagram of an access point device according to the embodiments of the present disclosure. The access point device 1100 shown in FIG. 15 includes:
a communication unit 1110, configured to receive a first feedback frame sent by at least one sensing response device, where the first feedback frame includes sensing reporting information.

In some embodiments, the sensing reporting information includes at least one of:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device;
threshold setting information, used to indicate a threshold of the sensing response device being used to feed back the change of the sensing measurement result; or
information of the change of the sensing measurement result, used to indicate the change of the sensing measurement result fed back by the sensing response device.

In some embodiments, the first feedback frame is an action frame.

In some embodiments, the first feedback frame is a public action frame or a sensing action frame.

In some embodiments, the first feedback frame includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a public action frame, the first feedback frame includes an action type field and a public action field, the action type field is used to indicate that the action frame is a public action frame, and a value of the public action domain field being a reserved value is used to indicate that the public action frame is a sensing feedback frame.

In some embodiments, the first feedback frame is a sensing action frame, the first feedback frame includes an action type field and a sensing action field, and a value of the action type field being a reserved value is used to indicate that the action frame is a sensing action frame, and the sensing action field is used to indicate that the sensing action frame is a sensing feedback frame.

In some embodiments, the first feedback frame includes an aggregation control (A-Control) field, and the sensing reporting information is carried in the A-Control field.

In some embodiments, the A-Control field includes a control identity field and a control information field, where the control identity field is used to indicate that the control information field is used to carry the sensing reporting information, and the control information field is used to carry the sensing reporting information.

In some embodiments, the control information field includes at least one of the following:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a data frame or a management frame.

In some embodiments, the communication unit 1110 is further configured to:
send a first trigger frame to at least one sensing response device, the first trigger frame including sensing reporting setup information, the sensing reporting setup information being used to determine a target sensing response device for sensing measurement reporting in the at least one sensing response device.

In some embodiments, the sensing reporting setup information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device; or threshold setting information, used to indicate a threshold that the sensing response device needs to satisfy for feeding back the change of the sensing measurement result.

In some embodiments, the first trigger frame includes an extremely high throughput (EHT) variant common information field and an EHT variant user information field, and the sensing reporting setup information is carried in the EHT variant common information field and/or the EHT variant user information field.

In some embodiments, the EHT variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the EHT variant common information field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the EHT variant user information field includes:
a threshold setting field, used to indicate a threshold that a station device corresponding to the EHT variant user information field needs to satisfy for feeding back a change of a sensing measurement result.

In some embodiments, the EHT variant common information field includes a field of a sensing trigger frame subtype, and the sensing trigger frame subtype is used to indicate a subtype of a sensing trigger frame being a sensing feedback poll trigger frame.

In some embodiments, the first trigger frame includes a high efficiency (HE) variant common information field and a HE variant user information field, and the sensing reporting setup information is carried in the HE variant common information field and/or the HE variant user information field.

In some embodiments, the HE variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or a threshold setting field, used to indicate a threshold that the sensing response device needs to satisfy for feeding back the change of the sensing measurement result.

In some embodiments, the HE variant common information field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the HE variant user information field includes:
a threshold setting field, used to indicate a threshold that a station device corresponding to the HE variant user information field needs to satisfy for feeding back a change of a sensing measurement result.

In some embodiments, the HE variant common information field includes a field of a sensing trigger frame subtype, and the sensing trigger frame subtype is used to indicate a subtype of a sensing trigger frame being a sensing feedback poll trigger frame.

Optionally, in some embodiments, the above-mentioned communication unit may be a communication interface or transceiver, or an input/output interface of a communication chip or a system on a chip.

It should be understood that the access point device 1100 according to the embodiments of the present disclosure may correspond to the access point device in the embodiments of methods of the present disclosure, and the above and other operations and/or functions of various units in the access point device 1100 are aimed to implement corresponding processes of the access point device in the method 200 shown in FIGS. 6-13, which may not be repeated herein for the sake of brevity.

FIG. 16 is a schematic block diagram of a sensing response device 1200 according to the embodiments of the present disclosure. As shown in FIG. 16, the sensing response device 1200 includes:
a communication unit 1210, configured to receive a first trigger frame sent by an access point device, where the first trigger frame includes sensing reporting setup information, and the sensing reporting setup information is used to determine the sensing response device to perform sensing measurement reporting.

In some embodiments, the sensing reporting setup information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device; or
threshold setting information, used to indicate a threshold that the sensing response device needs to satisfy for feeding back the change of the sensing measurement result.

In some embodiments, the first trigger frame includes an extremely high throughput (EHT) variant common information field and an EHT variant user information field, and the sensing reporting setup information is carried in the EHT variant common information field and/or the EHT variant user information field.

In some embodiments, the EHT variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the EHT variant common information field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the EHT variant user information field includes:
a threshold setting field, used to indicate a threshold that a station device corresponding to the EHT variant user information field needs to satisfy for feeding back a change of a sensing measurement result.

In some embodiments, the EHT variant common information field includes a field of a sensing trigger frame subtype, and the sensing trigger frame subtype is used to indicate a subtype of a sensing trigger frame being a sensing feedback poll trigger frame.

In some embodiments, the first trigger frame includes a high efficiency (HE) variant common information field and a HE variant user information field, and the sensing reporting setup information is carried in the HE variant common information field and/or the HE variant user information field.

In some embodiments, the HE variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the HE variant common information field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the HE variant user information field includes:
a threshold setting field, used to indicate a threshold that a station device corresponding to the HE variant user information field needs to satisfy for feeding back a change of a sensing measurement result.

In some embodiments, the HE variant common information field includes a field of a sensing trigger frame subtype, and the sensing trigger frame subtype is used to indicate a subtype of a sensing trigger frame being a sensing feedback poll trigger frame.

In some embodiments, the communication unit 1210 is further configured to:
send a first feedback frame to an access point device, where the first feedback frame includes sensing reporting information.

In some embodiments, the sensing reporting information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device;
threshold setting information, used to indicate a threshold of the sensing response device being used to feed back the change of the sensing measurement result; or
information of the change of the sensing measurement result, used to indicate the change of the sensing measurement result fed back by the sensing response device.

In some embodiments, the first feedback frame is an action frame.

In some embodiments, the first feedback frame is a public action frame or a sensing action frame.

In some embodiments, the first feedback frame includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a public action frame, the first feedback frame includes an action type field and a public action field, the action type field is used to indicate that the action frame is a public action frame, and a value of the public action domain field being a reserved value is used to indicate that the public action frame is a sensing feedback frame.

In some embodiments, the first feedback frame is a sensing action frame, the first feedback frame includes an action type field and a sensing action field, and a value of the action type field being a reserved value is used to indicate that the action frame is a sensing action frame, and the sensing action field is used to indicate that the sensing action frame is a sensing feedback frame.

In some embodiments, the first feedback frame includes an aggregation control (A-Control) field, and the sensing reporting information is carried in the A-Control field.

In some embodiments, the A-Control field includes a control identity field and a control information field, where the control identity field is used to indicate that the control information field is used to carry the sensing reporting information, and the control information field is used to carry the sensing reporting information.

In some embodiments, the control information field includes at least one of the following:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a data frame or a management frame.

Optionally, in some embodiments, the above-mentioned communication unit may be a communication interface or transceiver, or an input/output interface of a communication chip or a system on a chip.

It should be understood that the sensing response device 1200 according to the embodiments of the present disclosure may correspond to the sensing response device in the embodiments of methods of the present disclosure, and the above and other operations and/or functions of various units in the sensing response device 1200 are aimed to implement corresponding processes of the sensing response device in the method 200 shown in FIGS. 6-13, which may not be repeated herein for the sake of brevity.

FIG. 17 is a schematic block diagram of a sensing response device 1300 according to the embodiments of the present disclosure. As shown in FIG. 17, the sensing response device 1300 includes:
a communication unit 1310, configured to send a first feedback frame to an access point device, where the first feedback frame includes sensing reporting information.

In some embodiments, the sensing reporting information includes at least one of the following:
a measurement instance identity, used to identify a measurement instance;
a measurement setup identity, used to identify measurement setup for performing the measurement instance indicated by the measurement instance identity;
feedback type information, used to indicate a data type of a change of a sensing measurement result fed back by the sensing response device;
threshold setting information, used to indicate a threshold of the sensing response device being used to feed back the change of the sensing measurement result; or
information of the change of the sensing measurement result, used to indicate the change of the sensing measurement result fed back by the sensing response device.

In some embodiments, the first feedback frame is an action frame.

In some embodiments, the first feedback frame is a public action frame or a sensing action frame.

In some embodiments, the first feedback frame includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a public action frame, the first feedback frame includes an action type field and a public action field, the action type field is used to indicate that the action frame is a public action frame, and a value of the public action domain field being a reserved value is used to indicate that the public action frame is a sensing feedback frame.

In some embodiments, the first feedback frame is a sensing action frame, the first feedback frame includes an action type field and a sensing action field, and a value of the action type field being a reserved value is used to indicate that the action frame is a sensing action frame, and the sensing action field is used to indicate that the sensing action frame is a sensing feedback frame.

In some embodiments, the first feedback frame includes an aggregation control (A-Control) field, and the sensing reporting information is carried in the A-Control field.

In some embodiments, the A-Control field includes a control identity field and a control information field, where the control identity field is used to indicate that the control information field is used to carry the sensing reporting information, and the control information field is used to carry the sensing reporting information.

In some embodiments, the control information field includes at least one of the following:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device;
a threshold setting field, used to indicate a threshold of the sensing response device being used to feed back the change of the sensing measurement result; or
a field of the change of the sensing measurement result, used to indicate the change of the sensing measurement result fed back by the sensing response device.

In some embodiments, the first feedback frame is a data frame or a management frame.

In some embodiments, the communication unit 1310 is further configured to:
receive a first trigger frame sent by an access point device, where the first trigger frame includes sensing reporting setup information, and the sensing reporting setup information is used to determine the sensing response device to perform sensing measurement reporting.

In some embodiments, the sensing reporting setup information includes at least one of the following:
a measurement instance identity, used to identify a measurement instance;
a measurement setup identity, used to identify a measurement setup used to perform the measurement instance indicated by the measurement instance identity;
feedback type information, used to indicate a data type of a change of a sensing measurement result fed back by the sensing response device; or
threshold setting information, used to indicate a threshold that the sensing response device needs to satisfy for feeding back the change of the sensing measurement result.

In some embodiments, the first trigger frame includes an extremely high throughput (EHT) variant common information field and an EHT variant user information field, and the sensing reporting setup information is carried in the EHT variant common information field and/or the EHT variant user information field.

In some embodiments, the EHT variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the EHT variant common information field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the EHT variant user information field includes:
a threshold setting field, used to indicate a threshold that a station device corresponding to the EHT variant user information field needs to satisfy for feeding back a change of a sensing measurement result.

In some embodiments, the EHT variant common information field includes a field of a sensing trigger frame subtype, and the sensing trigger frame subtype is used to indicate a subtype of a sensing trigger frame being a sensing feedback poll trigger frame.

In some embodiments, the first trigger frame includes a high efficiency (HE) variant common information field and a HE variant user information field, and the sensing reporting setup information is carried in the HE variant common information field and/or the HE variant user information field.

In some embodiments, the HE variant common information field includes at least one of the following fields:
a measurement instance identity field, used to indicate an identity of a measurement instance;
a measurement setup identity field, used to indicate an identity of measurement setup;
a feedback type information field, used to indicate a data type of a change of a sensing measurement result fed back by the sensing response device; or
a threshold setting field, used to indicate a threshold that the sensing response device needs to satisfy for feeding back the change of the sensing measurement result.

In some embodiments, the HE variant common information field includes at least one of the following fields:
a measurement instance identity field, used to indicate an identity of a measurement instance;
a measurement setup identity field, used to indicate an identity of measurement setup; or
a feedback type information field, used to indicate a data type of a change of a sensing measurement result fed back by the sensing response device.

In some embodiments, the HE variant user information field includes:
a threshold setting field, used to indicate a threshold that a station device corresponding to the HE variant user information field needs to satisfy for feeding back a change of a sensing measurement result.

In some embodiments, the HE variant common information field includes a field of a sensing trigger frame subtype, and the sensing trigger frame subtype is used to indicate a subtype of a sensing trigger frame being a sensing feedback poll trigger frame.

Optionally, in some embodiments, the above-mentioned communication unit may be a communication interface or transceiver, or an input/output interface of a communication chip or a system on a chip.

It should be understood that the sensing response device 400 according to the embodiments of the present disclosure may correspond to the sensing response device in the embodiments of methods of the present disclosure, and the above and other operations and/or functions of various units in the sensing response device 400 are aimed to implement corresponding processes of the sensing response device in the method 200 shown in FIGS. 6-13, which may not be repeated herein for the sake of brevity.

FIG. 18 is a schematic structural diagram of a communication device 600 provided in the embodiments of the present disclosure. The communication device 600 shown in FIG. 18 includes a processor 610. The processor 610 may call and run a computer program from a memory to implement the methods in the embodiments of the present disclosure.

Optionally, as shown in FIG. 18, the communication device 600 may further include a memory 620. The processor 610 can call and run a computer program from the memory 620 to implement the methods in the embodiments of the present disclosure.

The memory 620 may be a separate device independent of the processor 610, or may be integrated into the processor 610.

Optionally, as shown in FIG. 6, the communication device 600 may further include a transceiver 630. The processor 610 can control the transceiver 630 to communicate with other devices, for example, to transmit information or data to other devices or to receive information or data transmitted by other devices.

The transceiver 630 may include a transmitter and a receiver. The transceiver 630 may further include an antenna, where one or more antennas can be provided.

Optionally, the communication device 600 may further be the sensing response device in the embodiments of the present disclosure, and the communication device 600 may implement the corresponding processes implemented by the sensing response device in the various methods in the embodiments of the present disclosure, which may not be repeated herein for sake of brevity.

Optionally, the communication device 600 may further be an access point device in the embodiments of the present disclosure, and the communication device 600 may implement the corresponding processes implemented by the access point device in the various methods in the embodiment of the present disclosure, which may not be repeated herein for sake of brevity.

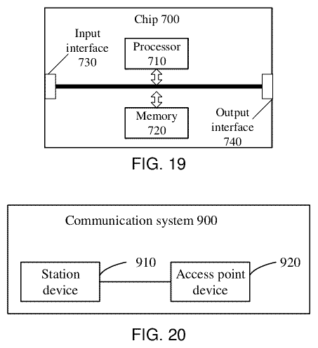

FIG. 19 is a schematic structural diagram of a chip of the embodiments of the present disclosure. The chip 700 shown in FIG. 19 includes a processor 710, which may call and run a computer program from a memory to implement the methods in the embodiments of the present disclosure.

Optionally, as shown in FIG. 19, the chip 700 may further includes a memory 720. The processor 710 may call and run the computer program from the memory 720 to implement the methods in the embodiments of the present disclosure.

The memory 720 may be a separate device independent of the processor 710, or may be integrated into the processor 710.

Optionally, the chip 700 may further include an input interface 730. The processor 710 can control the input interface 730 to communicate with other devices or chips, for example, to acquire information or data transmitted by other devices or chips.

Optionally, the chip 700 may further include an output interface 740. The processor 710 can control the output interface 740 to communicate with other devices or chips, for example, to output information or data to other devices or chips.

Optionally, the chip may be applied to the sensing response device in the embodiments of the present disclosure, and the chip may implement the corresponding processes implemented by the sensing response device in the various methods of the embodiments of the present disclosure, which may not be repeated herein for sake of brevity.

Optionally, the chip may be applied to the access point device in the embodiments of the present disclosure, and the chip may implement the corresponding processes implemented by the access point device in the various methods of the embodiments of the present disclosure, which may not be repeated herein for sake of brevity.

It should be understood that the chips mentioned in the embodiments of this application can also be called system-level chip, system chip, and chip system or system-on-chip chip.

FIG. 20 is a schematic block diagram of a communication system 900 provided in embodiments of the present disclosure. As shown in FIG. 20, a communication system 900 includes a station device 910 and an access point device 920.

The station device 910 may be used to implement the corresponding functions implemented by the sensing response device in the above-mentioned methods, and the access point device 920 may be used to implement the corresponding functions implemented by the access point device in the above-mentioned method, and which may not be repeated herein for the sake of brevity.

It should be understood that the processor in the embodiments of the present disclosure may be an integrated circuit chip and has signal processing capabilities. In the process of implementation, each step of the above-mentioned method embodiments can be implemented by an integrated logic circuit of hardware in a processor or an instruction in software form. The above-mentioned processor may be a general-purpose processor, a digital signal processor (Digital Signal Processor, DSP), an application specific integrated circuit (Application Specific Integrated Circuit, ASIC), a field programmable gate array (Field Programmable Gate Array, FPGA) or other programmable logic devices, a discrete gate or a transistor logic device, a discrete hardware component. The disclosed methods, steps, and logical block diagrams in the embodiments of the present disclosure can be implemented or executed. The general-purpose processor may be a microprocessor or any conventional processor. The steps of the method disclosed in combination with the embodiments of the present disclosure may be directly embodied as being performed and completed by a hardware decoding processor, or by using a combination of hardware and software modules in the decoding processor. The software module may be located in the mature storage medium in the art such as a random memory, a flash memory, a read-only memory, a programmable read-only memory or an electrically erasable programmable memory, a register, etc. The storage medium is located in the memory, and the processor reads information in the memory and completes the steps in the above-mentioned methods in combination with its hardware.

It can be understood that the memory in the embodiments of the present disclosure may be a volatile memory or a non-volatile memory, or may include both volatile and non-volatile memories. The non-volatile memory may be a read-only memory (Read-Only Memory, ROM), a programmable read-only memory (Programmable ROM, PROM), an erasable programmable read-only memory (Erasable PROM, EPROM), or an Electrically erasable programmable read-only memory (electrically EPROM, EEPROM) or a flash memory. The volatile memory may be a random access memory (Random Access Memory, RAM), which is used as an external cache. By way of illustration, but not limitation, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memories of the systems and methods described herein is intended to include, but is not limited to, these and any other suitable types of memories.

It should be understood that the above-mentioned memory is an exemplary but not restrictive description. For example, the memory in the embodiments of this application can also be static random access memory (static RAM, SRAM), dynamic random access memory (dynamic RAM, DRAM), synchronous dynamic random access memory (synchronous DRAM, SDRAM), double data rate synchronous dynamic random access memory (double data rate SDRAM, DDR SDRAM), enhanced synchronous dynamic random access memory (enhanced SDRAM, ESDRAM), synch link dynamic random access memory (synch link DRAM, SLDRAM), direct rambus random access memory (Direct Rambus RAM, DR RAM) etc. In other words, the memory in the embodiments of this application is intended to include, but is not limited to, these and any other suitable types of memories.

The embodiments of the present disclosure further provide a non-transitory computer-readable storage medium, configured to a computer program.

Optionally, the non-transitory computer-readable storage medium may be applied to the sensing response device in the embodiments of the present disclosure, and the computer program causes the computer to execute the corresponding processes implemented by the sensing response device in the various methods of the embodiments of the present disclosure, which may not be repeated herein for the sake of brevity.

Optionally, the non-transitory computer-readable storage medium may be applied to the access point device in the embodiments of the present disclosure, and the computer program causes the computer to execute the corresponding processes implemented by the access point device in the various methods of the embodiments of the present disclosure, which may not be repeated herein for the sake of brevity.

In the embodiments of the present disclosure, a computer program product including computer program instructions is further provided.

Optionally, the computer program product may be applied to the sensing response device in the embodiments of the present disclosure, and the computer program instructions cause a computer to execute the corresponding processes implemented by the sensing response device in the various methods of the embodiments of the present disclosure, which may not be repeated herein for the sake of brevity.

Optionally, the computer program product may be applied to the access point device in the embodiments of the present disclosure, and the computer program instructions cause a computer to execute the corresponding processes implemented by the access point device in the various methods of the embodiments of the present disclosure, which may not be repeated herein for the sake of brevity.

In the embodiments of the present disclosure, a computer program is further provided.

Optionally, the computer program may be applied to the sensing response device in the embodiments of the present disclosure, and upon being run on a computer, the computer program causes the computer to execute the corresponding processes implemented by the sensing response device in the various methods of the embodiments of the present disclosure, which may not be repeated herein for the sake of brevity.

Optionally, the computer program may be applied to the access point device in the embodiments of the present disclosure, and upon being run on a computer, the computer program causes the computer to execute the corresponding processes implemented by the access point device in the various methods of the embodiments of the present disclosure, which may not be repeated herein for the sake of brevity.

Those skilled in the art may realize that the units and algorithm steps of each example described in the disclosed embodiments can be implemented through electronic hardware, or a combination of computer software and electronic hardware. Whether these functions are performed by way of hardware or software depends on an application and a design constraint of the technical solution. A skilled person may use different methods for each application, to implement the described functions, but such implementation should not be considered beyond the scope of the present disclosure.

Those skilled in the art can clearly understand that for the convenience and brevity of the description, working processes of a system, an apparatus and a unit described above can refer to the corresponding processes in the foregoing method embodiments, and details are not described herein again.

In several embodiments provided by the present disclosure, it should be understood that the disclosed system, apparatus and method may be implemented in other ways. For example, the apparatus embodiments described above are only illustrative. For example, the division of units is only a logical function division, and there may be other division methods for actual implementation. For example, multiple units or components can be combined or integrated into another system, or some features may be ignored or may not be executed. On the other hand, the coupling or direct coupling or communicative connection between each other as shown or discussed above may be an indirect coupling or a communicative connection via some interfaces, apparatuses or units, which may be electrical, mechanical, or in other forms.

The units described as separate components may be or may not be physically separated, and the components shown as units may be or may not be physical units, that is, they may be located in one place or distributed across multiple network units. A portion or all of the units may be selected according to actual needs to implement the purpose of the embodiments.

In addition, the functional units in the embodiments of the present disclosure may be integrated into a single processing unit or the functional units may exist physically and separately, or two or more units may be integrated into one unit.

If the described functions are implemented in a form of a software functional unit and sold or used as an independent product, they may be stored in a non-transitory computer-readable storage medium. Based on this understanding, the technical solution of the present disclosure, or the portion that contributes to the existing technology or the portion of the technical solution, can be reflected in the form of a software product. The computer software product is stored in a storage medium, including several instructions to enable a computer device (which may be a personal computer, server, or network device, etc.) to perform all or a portion of the steps of the methods described in the various embodiments of the present disclosure. And the above described storage medium includes: a USB flash disk, a mobile hard disk, a read-only memory (Read-Only Memory, ROM), a random access memory (Random Access Memory, RAM), a disk or a CD, and other medium that can store program code.

The foregoing descriptions are merely some implementation manners of the preset application, but the protection scope of the preset application is not limited thereto; any person skilled in the art could readily conceive of changes or replacements within the technical scope of the preset application, which shall all be included in the protection scope of the preset application. Therefore, the protection scope of the present disclosure shall be subject to the protection scope of the claims.

What is claimed is:

1. A sensing method, comprising:
sending, by an access point device, a first trigger frame to at least one sensing response device, wherein the first trigger frame includes sensing reporting setup information, the sensing reporting setup information is used to determine a target sensing response device for sensing measurement reporting in the at least one sensing response device.

2. The method according to claim 1, wherein the first trigger frame comprises an extremely high throughput (EHT) variant common information field and an EHT variant user information field, and the sensing reporting setup information is carried in the EHT variant common information field and/or the EHT variant user information field.

3. The method according to claim 2, wherein the EHT variant common information field comprises a field of a sensing trigger frame subtype, and the sensing trigger frame subtype is used to indicate a subtype of a sensing trigger frame being a sensing feedback poll trigger frame.

4. The method according to claim 1, wherein the first trigger frame comprises a high efficiency (HE) variant common information field and a HE variant user information field, and the sensing reporting setup information is carried in the HE variant common information field and/or the HE variant user information field.

5. The method according to claim 4, wherein the HE variant common information field comprises a field of a sensing trigger frame subtype, and the sensing trigger frame subtype is used to indicate a subtype of a sensing trigger frame being a sensing feedback poll trigger frame.

6. The method according to claim 1, wherein the method further comprises:
receiving, by the access point device, a first feedback frame sent by the at least one sensing response device, wherein the first feedback frame comprises sensing reporting information.

7. The method according to claim 6, wherein the first feedback frame is an action frame;
wherein the first feedback frame comprises an aggregation control (A-Control) field, and the sensing reporting information is carried in the A-Control field.

8. A sensing method, comprising:
receiving, by a sensing response device, a first trigger frame sent by an access point device, wherein the first trigger frame comprises sensing reporting setup information, and the sensing reporting setup information is used to determine the sensing response device to perform sensing measurement reporting.

9. The method according to claim 8, wherein the first trigger frame comprises an extremely high throughput (EHT) variant common information field and an EHT variant user information field, and the sensing reporting setup information is carried in the EHT variant common information field and/or the EHT variant user information field.

10. The method according to claim 9, wherein the EHT variant common information field comprises a field of a sensing trigger frame subtype, and the sensing trigger frame subtype is used to indicate a subtype of a sensing trigger frame being a sensing feedback poll trigger frame.

11. The method according to claim 8, wherein the first trigger frame comprises a high efficiency (HE) variant common information field and a HE variant user information field, and the sensing reporting setup information is carried in the HE variant common information field and/or the HE variant user information field.

12. The method according to claim 11, wherein the HE variant common information field comprises a field of a sensing trigger frame subtype, and the sensing trigger frame subtype is used to indicate a subtype of a sensing trigger frame being a sensing feedback poll trigger frame.

13. The method according to claim 8, wherein the method further comprises:
sending, by the sensing response device, a first feedback frame to the access point device, wherein the first feedback frame comprises sensing reporting information.

14. An access point device, comprising:
a memory, configured to store a computer program;
a processor, configured to call and run the computer program stored in the memory; and
a transceiver, configured to send a first trigger frame to at least one sensing response device, wherein the first trigger frame includes sensing reporting setup information, the sensing reporting setup information is used to determine a target sensing response device for sensing measurement reporting in the at least one sensing response device.

15. The access point according to claim 14, wherein the first trigger frame comprises an extremely high throughput (EHT) variant common information field and an EHT variant user information field, and the sensing reporting setup information is carried in the EHT variant common information field and/or the EHT variant user information field.

16. The access point according to claim 15, wherein the EHT variant common information field comprises a field of a sensing trigger frame subtype, and the sensing trigger frame subtype is used to indicate a subtype of a sensing trigger frame being a sensing feedback poll trigger frame.

17. The access point according to claim 14, wherein the first trigger frame comprises a high efficiency (HE) variant common information field and a HE variant user information field, and the sensing reporting setup information is carried in the HE variant common information field and/or the HE variant user information field.

18. The access point according to claim 17, wherein the HE variant common information field comprises a field of a sensing trigger frame subtype, and the sensing trigger frame subtype is used to indicate a subtype of a sensing trigger frame being a sensing feedback poll trigger frame.

19. The access point according to claim 14, wherein the transceiver further configured to:
receive a first feedback frame sent by the at least one sensing response device, wherein the first feedback frame comprises sensing reporting information.

20. A sensing response device, comprising: a processor and a memory, wherein the memory is configured to store a computer program, the processor is configured to call and run the computer program stored in the memory to perform the method according to claim 8.
